(19) United States
(12) Patent Application Publication
(10) Pub. No.: US 2019/0272755 A1
(43) Pub. Date: Sep. 5, 2019

(54) INTELLIGENT VEHICLE AND METHOD FOR USING INTELLIGENT VEHICLE

(71) Applicant: Resilience Magnum IP, LLC, Cleveland, OH (US)

(72) Inventors: Michael E. Giorgi, Hudson, OH (US); Patrick M. Mause, Streetsboro, OH (US); Steven Rosen, Hunting Valley, OH (US)

(21) Appl. No.: 16/290,340

(22) Filed: Mar. 1, 2019

Related U.S. Application Data
(60) Provisional application No. 62/637,726, filed on Mar. 2, 2018.

(51) Int. Cl. G08G 1/16; H04W 4/46; G08G 1/0967; H04L 12/28

(52) U.S. Cl. CPC G08G 1/162; H04W 4/46; H04W 4/90; G08G 1/096791; H04L 12/2818; G08G 1/166

(57) ABSTRACT

Techniques regarding intelligent vehicles are provided herein. For example, one or more embodiments described herein can regard an intelligent vehicle that can comprise a sensor array configured to detect a parameter selected from a group comprising an internal parameter and an external parameter. The internal parameter can be associated with a first condition that is within the intelligent vehicle. The external parameter can be associated with a second condition that is outside the intelligent vehicle. The intelligent vehicle can also comprise a controller comprising processor, and the controller can be configured to generate a command based on the parameter. Further, the intelligent vehicle can comprise a communications interface configured to send the command to a device located outside the intelligent vehicle.

### CROSS-REFERENCE TO RELATED APPLICATIONS

This application claims priority to U.S. Provisional Patent Application Ser. No. 62/637,726 filed on Mar. 2, 2018, entitled “INTELLIGENT VEHICLE AND METHOD FOR USING INTELLIGENT VEHICLE.” The entirety of the aforementioned application is incorporated by reference herein.

### BACKGROUND

The subject disclosure relates to the field of automotive automation. More particularly to methods and systems for interaction of an intelligent vehicle with a plurality of peripherals.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular implementations of the specification, or any scope of the claims. Its purpose is to present some concepts of the specification in a simplified form as a prelude to the more detailed description that is presented in this disclosure. In one or more embodiments described herein, apparatuses, systems, and/or methods regarding intelligent vehicles are depicted.

According to an embodiment, an intelligent vehicle is provided. The intelligent vehicle can comprise a sensor array that can be configured to detect a parameter selected from a group comprising an internal parameter and an external parameter. The internal parameter can be associated with a first condition that is within the intelligent vehicle. The external parameter can be associated with a second condition that is outside the intelligent vehicle. The intelligent vehicle can also comprise a controller comprising processor, and the controller can be configured to generate a command based on the parameter. Further, the intelligent vehicle can comprise a communications interface that can be configured to send the command to a device located outside the intelligent vehicle.

According to another embodiment, a computer-implemented method is provided. The computer-implemented method can comprise detecting, by a system operatively coupled to a processor of an intelligent vehicle, a parameter selected from a group comprising an internal parameter and an external parameter. The internal parameter can be associated with a first condition that can be within the intelligent vehicle. The external parameter can be associated with a second condition that can be outside the intelligent vehicle. The computer-implemented method can also comprise generating, by the system, a command based on the parameter. Further, the computer-implemented method can comprise sharing, by the system, the command with a device located outside the intelligent vehicle.

According to another embodiment, a system for an intelligent vehicle is provided. The system can comprise a memory that can store computer executable components. The system can also comprise a processor, operably coupled to the memory, that can execute the computer executable components stored in the memory. The computer executable components can comprise a sensor component that can detect a parameter selected from a group comprising an internal parameter and an external parameter. The internal parameter can be associated with a first condition that can be within the intelligent vehicle. The external parameter can be associated with a second condition that can be outside the intelligent vehicle. The computer executable components can also comprise a controller component that can generate a command based on the parameter. Further, the computer executable components can comprise a communication component that can share the command with a device located outside the intelligent vehicle.

### BRIEF DESCRIPTION OF THE DRAWINGS

Numerous aspects, implementations, and advantages of the present invention will be apparent upon consideration of the following detailed description, taken in conjunction with the accompanying drawings, in which like reference characters refer to like parts throughout.

FIG. 1 illustrates a diagram of an example, non-limiting intelligent vehicle that can comprise an array of sensors, a communications interface, and/or a controller in accordance with one or more embodiments described herein.

FIG. 2 illustrates a diagram of an example, non-limiting interior of an intelligent vehicle that can comprise various communication devices in accordance with one or more embodiments described herein.

FIG. 3 illustrates a diagram of an example, non-limiting scenario wherein an intelligent vehicle can encounter an object in accordance with one or more embodiments described herein.

FIG. 4 illustrates a diagram of an example, non-limiting scenario wherein an intelligent vehicle and a second intelligent vehicle can encounter each other in accordance with one or more embodiments described herein.

FIG. 5 illustrates a diagram of an example, non-limiting scenario wherein an intelligent vehicle can encounter an intelligent building in accordance with one or more embodiments described herein.

FIG. 6 illustrates a diagram of an example, non-limiting interior of an intelligent vehicle in accordance with one or more embodiments described herein.

FIG. 7 illustrates a diagram of an example, non-limiting alarm that can be included in an intelligent vehicle and/or facilitate occupant detection in accordance with various aspects disclosed herein;

FIG. 8 illustrates a diagram of an example, non-limiting communication that can be generated by an intelligent vehicle in response to occupant detection in accordance with one or more embodiments described herein.

FIG. 9 illustrates a diagram of an example, non-limiting communication with one or more law enforcement agents that can be generated by an intelligent vehicle in response to occupant detection in accordance with one or more embodiments described herein.

FIG. 10 illustrates a flow diagram of an example, non-limiting method in which an intelligent vehicle can detect a condition and execute an action in response to said detection in accordance with one or more embodiments described herein.

FIG. 11 illustrates a flow diagram of an example, non-limiting method that can facilitate determining an occupancy of an intelligent vehicle and initiating an alert in response to said determining in accordance with one or more embodiments described herein.

FIG. 12 illustrates a flow diagram of an example, non-limiting method that can facilitate determining road conditions, alerting a user/occupant of an intelligent vehicle, and/or sending a message to a second intelligent vehicle in accordance with one or more embodiments described herein.

FIG. 13 illustrates a flow diagram of an example, non-limiting method that can facilitate preparing one or more operation protocols for an intelligent vehicle in response to a calendar or meeting event in accordance with one or more embodiments described herein.

FIG. 14 illustrates a flow diagram of an example, non-limiting method that can regard alerting a user of an intelligent vehicle to the location of said intelligent vehicle in response to a registered smartphone entering defined proximity in accordance with one or more embodiments described herein.

FIG. 15 illustrates a flow diagram of an example, non-limiting method that can facilitate interfacing one or more intelligent vehicles with one or more devices comprising a building (e.g., a residence) in accordance with one or more embodiments described herein.

FIG. 16 illustrates a flow diagram of an example, non-limiting method that can facilitate an intelligent vehicle interfacing with one or more devices in a building (e.g., a residence) in accordance with one or more embodiments described herein.

FIG. 17 illustrates another flow diagram of an example, non-limiting method that can facilitate an intelligent vehicle interfacing with one or more devices in a building (e.g., a residence) in accordance with one or more embodiments described herein.

FIG. 18 is a diagram of an example, non-limiting computing environment that can facilitate operation of an intelligent vehicle in accordance with one or more embodiments described herein.

FIG. 19 is a diagram of an example, non-limiting computing environment that can facilitate operation of an intelligent vehicle in accordance with one or more embodiments described herein.

### DETAILED DESCRIPTION

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing this disclosure.

The proliferation, advancement, and affordability of vehicles containing intelligent functionality have facilitated the expansion of vehicle features to be more available to the general public than ever before. Advancements in sensors, computer systems and communications devices have a common place in vehicles. For example, information obtained by an intelligent vehicle can be useful for navigation or for monitoring when one interested in monitoring the intelligent vehicle is not proximal to the intelligent vehicle. There is an unmet need by the state of the art for more robust features surrounding features of vehicles.

Systems and methods disclosed herein can relate to an intelligent vehicle and communication between internal and external entities. The intelligent vehicle can be coupled to an electronic processor. The intelligent vehicle can gather information from an array of sensors to assist a user of an intelligent vehicle concerning various internal/external conditions/hazards on a route as well as interface with other connected technology to provide a robust user experience. The intelligent vehicle can interface with, but is not limited to, another intelligent vehicle or an intelligent home/residence. The intelligent vehicle can interface with, but is not limited to, another intelligent vehicle or an “intelligent home”, for example. As used herein, the term “intelligent home” can refer to, but is not limited to, a building (e.g., a residence) with a connected hub connected to electronic devices, such as a building (e.g., a residence) containing devices connected to the internet and accessible by other devices as well as apartments or condos with similar features.

In one or more embodiments, an array of sensors can be coupled to a controller and a communications interface in addition to the systems of the intelligent vehicle including, but not limited to, an engine control module (“ECM”), controller area network (“CAN”), CANbus, on-board diagnostic system (“OBD-II”), powertrain control module (“PCM”), and/or the like. The communications interface can facilitate communication with a plurality of external sources, which can include, but are not limited to: other intelligent vehicles, smartphones, smart homes, wireless devices, a combination thereof, and/or law enforcement agencies. The communications interface facilitates communication with a plurality of external devices. The communications interface can utilize a plurality of mediums, including, but not limited to: IR, shortwave transmission, NFC, Bluetooth, Wifi, LTE, GSM, CDMA, satellite, visual cues and radio waves among others. The intelligent vehicle can store, via an internal memory, settings of a plurality of users so that an experience is personalized for each user. Also, the intelligent vehicle can store in internal memory settings of a plurality of users so that an experience is personalized for each user. Personalization could include which external devices to interface with such as devices of a smart home. The intelligent vehicle can detect the presence of an individual forgotten in the intelligent vehicle, such as a child, pet or incapacitated person. The intelligent vehicle can take an action upon the detection, such as sound an alarm and flash lights.

In another embodiment, the intelligent vehicle can wirelessly connect to an external source to relay a distress message of an occupant trapped in the intelligent vehicle. For example, external sources can include law enforcement and the smartphone or other device containing a processor of a registered user of the intelligent vehicle. In another embodiment, the intelligent vehicle can output and/or input information regarding a roadway to and/or from a second intelligent vehicle. A leading intelligent vehicle can send information to a trailing intelligent vehicle regarding road conditions observed and experienced. The trailing intelligent vehicle can confirm or reject the conditions and communicate the confirmation or rejection to the leading intelligent vehicle. This information can be stored in memory for future routing and alerting purposes.

In another embodiment, the intelligent vehicle can wirelessly connect to a law enforcement agency via a communications interface upon the detection via a sensor array of an “at risk” entity being forgotten inside the intelligent vehicle. The at risk individual can comprise, but is not limited to a child, pet or incapacitated person. A controller can send a message to the law enforcement agency indicating the entity needing attention. Law enforcement could then respond and assist the individual, for example a pet, child or incapacitated adult, reducing the risk of injury or death.

In another embodiment, the intelligent vehicle can wirelessly connect to a smartphone of a user of the intelligent vehicle via a wireless communication interface. A message can be sent to the smartphone upon execution by a controller from the detection of an “at risk” entity, via a sensor array, being forgotten inside the intelligent vehicle. The user of the intelligent vehicle could then respond and assist the individual, reducing the risk of injury or death. In a further example, the intelligent vehicle can, in response to the detection of an “at risk” entity via a sensor, activate the climate control system to reduce the risk of frostbite or hyperthermia due to an extreme temperature via a controller communicating with the systems of the intelligent vehicle.

In another embodiment, the intelligent vehicle can detect the presence of an “at risk” entity via a sensor array and via the instruction of a controller can include, but is not limited to, activating an alarm, and flashing lights, thereby alerting nearby persons of the entity requiring assistance. The intelligent vehicle could, for example, automatically unlock and/or open the doors so that a nearby person can simply open the door vs. utilize a method requiring force.

In another embodiment, an intelligent vehicle can detect a leading vehicle (e.g., without intelligent functionality). The intelligent vehicle can still detect actions taken by the leading vehicle, such as experiencing a pothole and/or making sudden movements. In response to these exemplary detections, the intelligent vehicle can alert a user of the intelligent vehicle. In another embodiment, an intelligent vehicle can interface with an intelligent building to automate tasks such as music transfer and control functions such as enabling and disabling air conditioning, garage doors and other connected features.

In another embodiment, the intelligent vehicle can output and input information regarding a roadway to/from a second intelligent vehicle via a communications interface. A leading intelligent vehicle sends information to a trailing intelligent vehicle regarding road conditions observed via an array of sensors. The trailing intelligent vehicle can confirm or reject the conditions via a controller and communicate the confirmation or rejection to the leading intelligent vehicle via communications interfaces of both intelligent vehicles. This information can be stored in memory of both intelligent vehicles for future routing and alerting purposes.

In another embodiment, an intelligent vehicle can via a communications interface and controller, interface with devices in a home, or smart home, to automate tasks such as music transfer. A song, playlist, radio station or other music medium can be playing inside a home. The music can seamlessly transfer to the intelligent vehicle. The reverse can also occur, wherein a transfer from the intelligent vehicle to the home occurs. Navigation instructions can be transferred from a home computer or mobile device automatically to the intelligent vehicle via the communications interface. Photos and videos can also be transferred to and from the intelligent vehicle to an external device such as a mobile device or home PC. This could be used for, but is not limited to, the transfer of movies, TV shows, pictures, for use on an infotainment system and dashboard camera recordings among other forms of digital content.

In another example, an intelligent vehicle can via a communications interface and a controller, interact with connected devices in a home and control via controller, control functions such as enabling and disabling air conditioning, garage doors, home door locks and other connected devices such as electronic window blinds, windows and others. The intelligent vehicle can automatically control lights of a home, disarm or arm a home security system and set a home thermostat based upon at least one of a plurality of conditions. The intelligent vehicle can alert the devices of the home that the intelligent vehicle has arrived, for example, to alert home occupants to come to the intelligent vehicle to help carry groceries or other items. Functions could be dependent upon preferences of a user of the intelligent vehicle and can vary depending on the user. Preference options can be preset and/or user defined.

In another embodiment, the intelligent vehicle can turn itself on or start its engine at a predetermined time. This predetermined time can be determined, for example, from a calendar event. The intelligent vehicle can, in response to a calendar event taking place in one hour, start/activate the intelligent vehicle one hour and five minutes in order to heat or cool the intelligent vehicle. Five minutes is purely an example, and can be any amount of time. This amount of time can be set by a user of the intelligent vehicle and/or predefined.

In another example, the intelligent vehicle can turn itself on or start its engine in response to the proximity of a user of the intelligent vehicle. This proximity could be determined by the proximity of a smartphone of a user of the intelligent vehicle or via a sensor of the array of sensors detecting a specific identity corresponding with a user of the intelligent vehicle.

In another example, the intelligent vehicle can flash lights and/or sound a horn/siren in response to the proximity of a user of the intelligent vehicle. This proximity could be determined by the proximity of a smartphone of a user of the intelligent vehicle or via a sensor of the array of sensors detecting a specific identity corresponding with a user of the intelligent vehicle. This can be helpful for identifying the intelligent vehicle in a crowded parking area or in an absence of ambient light.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

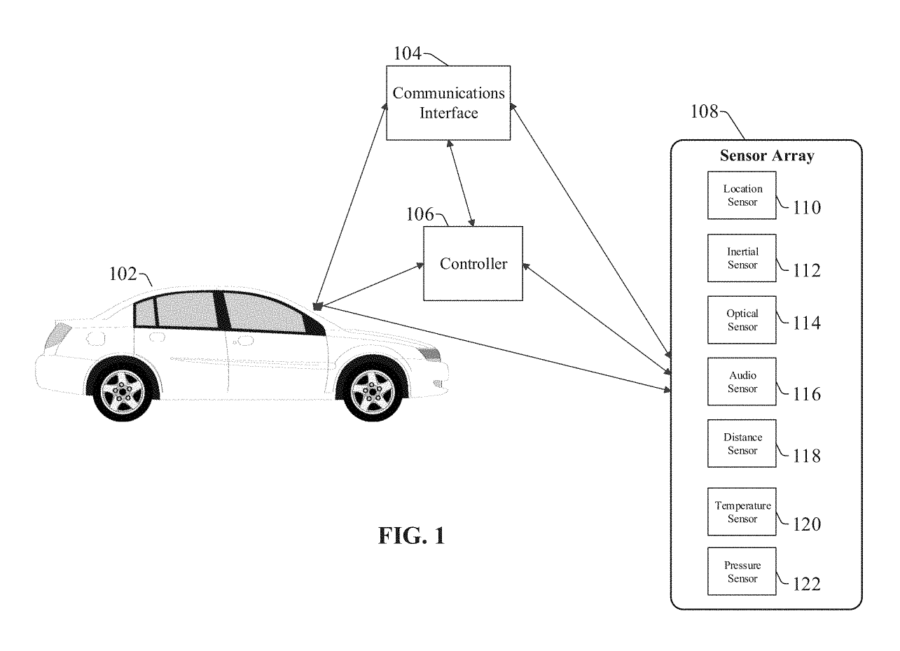

FIG. 1 illustrates a diagram of an example, non-limiting intelligent vehicle 102 in accordance with one or more embodiments described herein. The intelligent vehicle 102 can comprise a communications interface 104, a controller 106, and/or a sensor array 108. The intelligent vehicle 102 can further comprise a number of integrated vehicle systems such as an ECM, CAN, CANbus, OBD-II, PCM, a combination thereof, and/or the like.

The communications interface 104 can perform a plurality of functions relating to communications via wired and/or wireless technologies. For example, wireless technologies that can be utilized by the communications interface 104 can include, but are not limited to: IR, shortwave transmission, NFC, Bluetooth, Wifi, LTE, GSM, CDMA, satellite, visual cues and radio among others. The communications interface 104 is coupled to the intelligent vehicle 102 and contains a processor and memory. The communications interface 104 can be located in one or more positions within the intelligent vehicle 102. For example, the communications interface 104 be embedded along with other features of the intelligent vehicle 102. For instance, the communications interface 104 can be located on a roofline of the intelligent vehicle 102 to facilitate wireless transmission.

Controller 106 can be coupled to the intelligent vehicle 102 and can comprise a processor and/or memory. In various embodiments, the controller 106 can control the sensor array 108, various functions of the intelligent vehicle 102, and/or the communications interface 104. For example, the controller 106 can be wirelessly coupled and/or wired directly to the intelligent vehicle 102 to facilitate communication (e.g., electrical communication) with the communications interface 104 and/or the sensor array 108. Controller 106 can also be connected to any of the individual sensors of sensor array 108 and can be connected to any feature/device of the intelligent vehicle 102.

Sensor array 108 contains a plurality of sensors. In various embodiments, the sensor array 108 can comprise location sensor 110, inertial sensor 112, optical sensor 114, audio sensor 116, distance sensor 118, temperature sensor 120, and/or pressure sensor 122. Sensor array 108 can be a single unit and/or a grouping of sensors. The sensor array 108 can be located in one or more positions throughout the intelligent vehicle 102 (e.g., with or without being physically attached to each other or a central device). These sensor array 108 can detect conditions internal to the intelligent vehicle 102 such as the presence of an entity or to confirm that the intelligent vehicle 102 is empty. The sensor array 108 can enable a user to detect whether an object is located in the intelligent vehicle 102 (e.g., left in the intelligent vehicle 102). In another example, the sensor array 108 can detect conditions external to the intelligent vehicle 102, which can include, but are not limited to: road cracks, potholes, debris on a road, ice, snow, oil, water, sinkholes, manholes, roadkill, animals on a road, humans on a road, vehicle parts, air quality, disabled vehicles, parked vehicles, other intelligent vehicles 102, downed power lines among a plurality of others conditions relevant to an intelligent vehicle 102 or an occupant and/or driver of an intelligent vehicle 102.

Location sensor 110 can be coupled to the intelligent vehicle 102 and can be used for determining the position of the intelligent vehicle 102. Technologies utilized by the location sensor 110 can include, but are not limited to: global positioning systems (“GPS”), Glonass, LORAN, wireless triangulation, a combination thereof, and/or the like. Also, the location sensor 110 can communicate with controller 106 and/or communications interface 104.

The inertial sensor 112 can also be coupled to the intelligent vehicle 102. It can be used to detect road conditions by measuring an abrupt motion change of an intelligent vehicle 102 caused by, for example but not limited to, a pothole. In another embodiment, inertial sensor 112 can be used to detect the presence of an entity in an intelligent vehicle 102. It could be used to detect a moving entity within the intelligent vehicle 102. Additionally, an optical sensor 114 can be coupled to the intelligent vehicle 102 and can be used to detect a plurality of visual conditions. In one embodiment, the optical sensor 114 can be used to detect abnormalities in roadways or other vehicles of a roadway using one or more imaging technologies. Data collected by the inertial sensor 112 and/or the optical sensor 114 can be relayed to the controller 106 and/or communications interface 104 for action to be taken by the intelligent vehicle 102.

In another embodiment, the optical sensor 114 can detect conditions internal to the intelligent vehicle 102. For example, the optical sensor 114 can capture the presence of entities in the intelligent vehicle 102 (e.g., an organism and/or inanimate object). Data captured by the optical sensor 114 can initiate an alert or allow a user of the intelligent vehicle 102 to see a live or recorded image or video of contents of the intelligent vehicle. In another example, the optical sensor 114 can provide a user, and/or any other individual of interest, the status of an occupant inside of the intelligent vehicle 102. For example, the optical sensor 114 can be used to detect movement to see if the occupant is alert or incapacitated.

An audio sensor 116 can also be coupled to the intelligent vehicle 102 and can be used to perform audio recognition of an occupant. This can be particularly useful in reducing false-positive detections of an “at risk” entity. For example, wherein a user of the intelligent vehicle 102 is retrieving items from an otherwise unoccupied intelligent vehicle 102, the audio sensor 116 can confirm an identity of the user of the intelligent vehicle 102 and prevent the intelligent vehicle from identifying an individual as “at risk.” In another example, audio sensor 116 can accept verbal commands. An example of a verbal command can include, but is not limited to, “I'm okay” to signify to the intelligent vehicle 102 (e.g., the controller 1106) that an entity inside the intelligent vehicle 102 is not at risk, thereby preventing triggering of an alert.

In another example, audio sensor 116 can accept voice commands relating to operation of the intelligent vehicle 102. For example, a user of the intelligent vehicle 102 can command the intelligent vehicle 102 to “open garage” and the audio sensor 116 can process the audio, the controller 106 can generate a command based on the audio, and the communications interface 104 can send the command to an intelligent building with a connected garage, which can open subject to the command.

The sensor array 108 can also comprise a distance sensor 118, which can be coupled to the intelligent vehicle 102. The distance sensor 118 can utilize a variety of technologies, which can include, but are not limited to: radar, sonar and lidar. For example, an echo of waves can be generated by the distance sensor 118 and used to determine an object's distance from the intelligent vehicle 102. In one or more embodiments, the distance sensor 118 can be used to detect abnormalities in roadways or other vehicles of a roadway. Data collected by the distance sensor 118 can be relayed to the controller 106 and/or communications interface 104 for action to be taken by the intelligent vehicle 102. In another embodiment, distance sensor 118 can detect movement or the presence of an individual within intelligent vehicle 102.

The sensor array 108 can further comprise temperature sensor 120 coupled to an intelligent vehicle 102 and can detect thermal energy of an entity within the intelligent vehicle 102 to check if the entity is a living organism or just an inanimate object. In another example, temperature sensor 120 can detect the internal temperature of the intelligent vehicle 102. It can take such a reading even when the intelligent vehicle 102 is not running. In this example, the intelligent vehicle 102 can determine whether the internal temperature of the intelligent vehicle 102 is unsafe for a living being (e.g., within a defined temperature range). In another example, temperature sensor 120 can detect a thermal signature of a user of an intelligent vehicle 102 approaching the intelligent vehicle 102. In a further example, temperature sensor 120 can detect ambient temperature outside of the intelligent vehicle 102.

Moreover, the sensor array 108 can comprise a pressure sensor 122 coupled to the intelligent vehicle 102, which can detect an entity inside of the intelligent vehicle 102. Pressure sensor 122 can be embedded in a seat, floor, trunk or other area of the intelligent vehicle 102 in order to detect the presence of an entity. For example, the pressure sensor 122 can detect changes in pressure (e.g., pressure applied to a seat of the intelligent vehicle 102), which can aid in determining whether an entity is moving inside of the intelligent vehicle 102. In another embodiment, pressure sensor 122 can be coupled to the intelligent vehicle 102 in order to determine changes in road conditions. In one non-limited example, the pressure sensor 122 can be coupled to a shock, spring or strut of the intelligent vehicle 102 and measure changes in pressure. Data collected by the pressure sensor 122 can be relayed to communications interface 104 and controller 106.

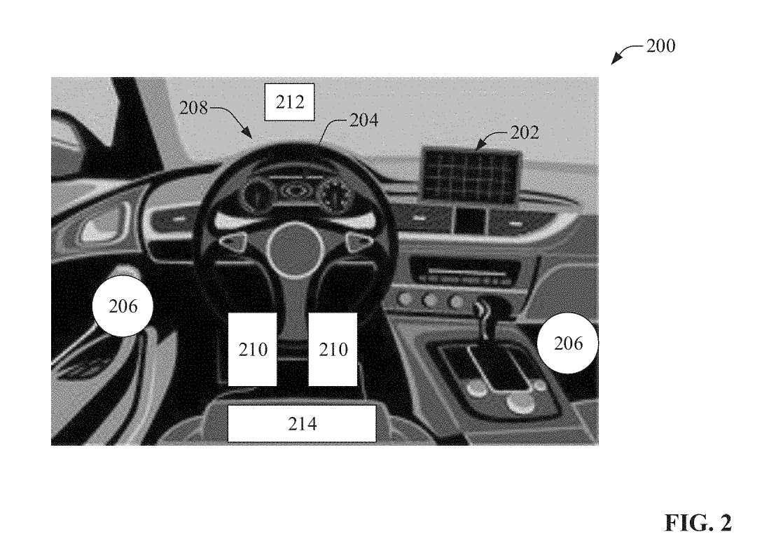

FIG. 2 illustrates a diagram of an example, non-limiting frontal interior 200 of an intelligent vehicle 102 in accordance with one or more embodiments described herein. Repetitive description of like elements employed in other embodiments described herein is omitted for sake of brevity. Frontal interior 200 can alert a user of the intelligent vehicle 102 of a message or notification via a plurality of communications methods and devices (e.g., communications interface 104). Frontal interior 200 can also comprise and/or be operably coupled to the sensor array 108.

A screen 202 of the frontal interior 200 can be coupled to intelligent vehicle 102, the controller 106, and/or the communications interface 104. For example, the screen 202 can comprise, but not limited to: a liquid crystal display (“LCD”), a light-emitting diode (“LED”), an organic LED (“OLED”), an active-matrix OLED (“AMOLED”), a cathode ray tube (“CRT”) display, a three-dimensional (“3D”) display, a stereoscopic display, a projector display, a combination thereof, and/or the like. For instance, the screen 202 can comprise a touch interface, such as, but not limited to: Resistive, Surface Capacitive, Projected Capacitive, Surface Acoustic Wave (“SAW”), Infrared, a combination thereof, and/or the like.

In one non-limiting embodiment, screen 202 can display a message (e.g., generated by the controller 106) to a user of the intelligent vehicle 102. Example messages can include, but are not limited to, a message pertaining to the status of: the intelligent vehicle 102, another vehicle (e.g., another intelligent vehicle 102), a roadway, and/or an occupant within the intelligent vehicle 102, a combination thereof, and/or the like.

In another embodiment, screen 202 can accept input via touching the display. Such input can be used for initiating a command to be sent to controller 106 and the command can be handed off to communications interface 104. Such a command can include, but is not limited to, enable lights of an intelligent building, change the temperature of a thermostat connected to an a/c or heater of an intelligent building, open/close a garage door and/or lock a door of an intelligent building, and/or the like. In another embodiment, screen 202 can include a haptic engine to provide haptic feedback in response to touch, which can assist in the confirmation of an input by a user.

Display 204 of frontal interior 200 can be coupled to intelligent vehicle 102, the controller 106, and/or and the communications interface 104. Display 204 can be used to perform a plurality of tasks. Display 204 can be one of, but not limited to, LCD, OLED, LED, AMOLED, CRT, 3D, stereoscopic, projector and others. Touch interface for the display can be one of, but not limited to, Resistive, Surface Capacitive, Projected Capacitive, SAW (Surface Acoustic Wave) and Infrared. In another embodiment, display 204 can include a haptic engine to provide haptic feedback in response to touch, which can assist in the confirmation of an input by a user.

In one non-limiting embodiment, display 204 can show a message to a user of the intelligent vehicle 102. A message can be generated by the controller 106 and shown to the user via the display 204. For example, the message can pertain to the status of: the intelligent vehicle 102, another vehicle (e.g., a second intelligent vehicle 102), the roadway, an occupant inside the intelligent vehicle 102, a combination thereof, and/or the like.

One or more speakers 206 of frontal interior 200 can also be coupled to intelligent vehicle 102, the controller 106, and/or the communications interface 104. The one or more speakers 206 can be used to perform a plurality of audio tasks. In one embodiment, the one or more speakers 206 can output audio of an alert (e.g., generated by the controller 106) for a user of the intelligent vehicle 102. For example, the alert (e.g., generated by the controller 106) can regard a status (e.g., as determined by the sensor array 108) of the intelligent vehicle 102 and/or a road condition.

Additionally, a steering wheel 208 of frontal interior 200 can be coupled to intelligent vehicle 102, the controller 106, and/or the communications interface 104. The steering wheel 208 can be used to perform a plurality of tasks in addition to the basic task of steering the intelligent vehicle 102. The steering wheel 208 can be made from at least one of a variety of materials including, but not limited to: cloth, wood, leather, plastic, vinyl, suede, polyester, alcantara and metal materials, a combination thereof, and/or the like.

In one embodiment, the steering wheel 208 can include haptic feedback driven by a haptic engine. In this example, steering wheel 208 can pulse or vibrate when a user of the intelligent vehicle 102 is to be alerted. The haptic feedback can obtain the attention of a user of intelligent vehicle 102 and further specify the alert with the one or more speakers 206, the display 204, and/or the screen 202.

Pedals 210 of frontal interior 200 are coupled to intelligent vehicle 102, a controller 106 and communications interface 104. Pedals 210 can be used to perform a plurality of tasks in addition to providing input to the intelligent vehicle, such as for accelerating and/or braking. In various embodiments, one or more pedals 210 can include haptic feedback driven by a haptic engine. In this example, pedals 210 can pulse and/or vibrate when a user of the intelligent vehicle 102 is to be alerted. The haptic feedback can get the attention of a user of intelligent vehicle 102 and further specify the alert with the one or more speakers 206, the display 204, and/or the screen 202.

Additionally, a heads-up-display (“HUD”) 212 of frontal interior 200 can be coupled to intelligent vehicle 102, the controller 106, the communications interface 104, and/or the sensor array 108. In one or more embodiments, the HUD 212 can be projected onto a windshield (e.g., a front windshield) and/or window of the intelligent vehicle 102 to provide information to a user of the intelligent vehicle 102. For example, an alert (e.g., generated by the controller 106) regarding a road condition can be conveyed to a user via the HUD 212. For instance, the HUD 212 can display a plurality of conditions and messages relating to intelligent vehicle 102 and/or navigation.

Further, one or more seats 214 of frontal interior 200 can be coupled to the intelligent vehicle 102, the controller 106, the sensor array 108, and/or the communications interface 104. The one or more seats 214 can be used to perform a plurality of tasks in addition to providing a place from which to occupy and/or control the intelligent vehicle 102. In one or more embodiments, the one or more seats 214 can include haptic feedback driven by a haptic engine. For example, the one or more seats 214 can pulse or vibrate when a user of the intelligent vehicle 102 is to be alerted (e.g., as determined by the controller 106). The haptic feedback can get the attention of a user of intelligent vehicle 102 and further specify the alert with the one or more speakers 206, the display 204, the screen 202, and/or the HUD 212. Thus, in one or more embodiments, the various features of the frontal interior 200 can act independently, or in combination, to convey an alert (e.g., generated by the controller 106) to a user of the intelligent vehicle 102, wherein the alert can be based on a received signal (e.g., via the communications interface 104) and/or data collected by the sensor array 108.

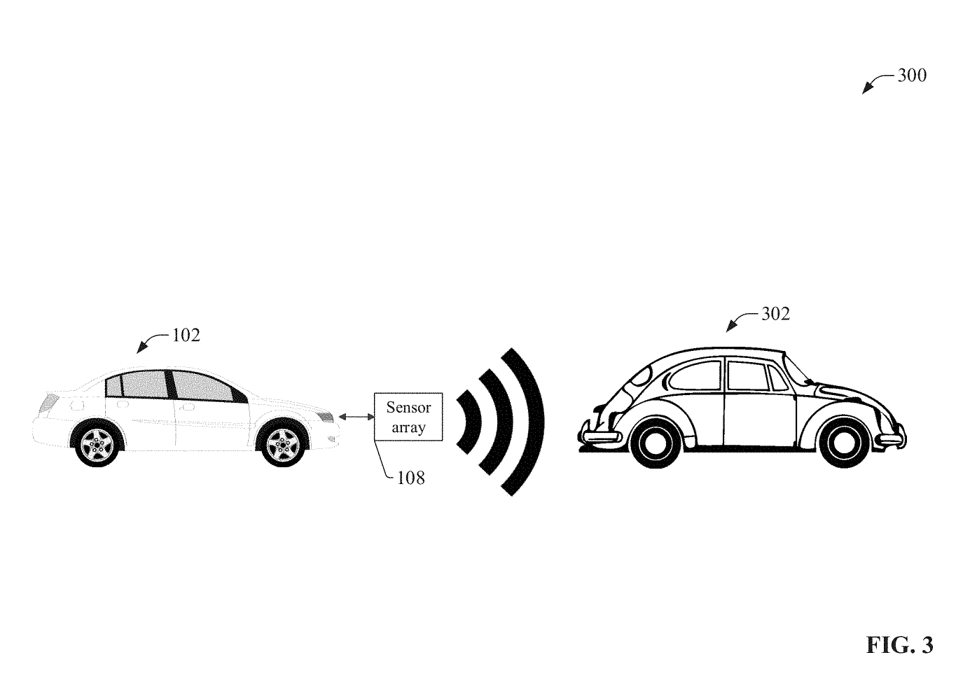

FIG. 3 illustrates an example, non-limiting exemplary scenario 300 in which the intelligent vehicle 102 can encounters a vehicle 302 (e.g., which does not comprise the intelligent capabilities at least similar to intelligent vehicle 102) in accordance with one or more embodiments described herein. Repetitive description of like elements employed in other embodiments described herein is omitted for sake of brevity. In scenario 300, the intelligent vehicle 102 can be trailing vehicle 302. The intelligent vehicle 102 can gather information concerning the roadway and vehicle 302 via the sensor array 108 and/or the communications interface 104.

For example, wherein vehicle 302 encounters a pothole on a roadway, the intelligent vehicle 102 (e.g., via its sensor array 108) can detect the sudden motion of vehicle 302 and convey (e.g., via one or more features of the frontal interior 200) an alert (e.g., generated by the controller 106) to a user of intelligent vehicle 102 regarding the existence and/or location of the pothole and/or other roadway conditions. While encountering a pothole is used for exemplary purposes, the intelligent vehicle 102 can detect any condition/event that alters the status of the vehicle 302, which can include, but are not limited to: a flat tire, a part falling off the vehicle 302, an irregular trajectory of the vehicle 302 (e.g., cause by a sliding of the vehicle 302) a bump in the road experienced by vehicle 302, a combination thereof, and/or the like.

In another example, the vehicle 302 can be applying its brakes, thereby causing its brake lights to illuminate. The intelligent vehicle 102 can detect the illumination of the brake lights of vehicle 302 (e.g., via the sensor array 108) and convey (e.g., via the frontal interior 200) an alert (e.g., generated by the controller 106) to a user of intelligent vehicle 102 that vehicle 302 may be slowing down. The intelligent vehicle 102 can also detect the deceleration of vehicle 302 by noticing a change in distance between vehicle 302 and intelligent vehicle 102. An alert (e.g., generated by the controller 106) can be displayed (e.g., via the display 204, the screen 202, and/or the HUD 212) to the user of intelligent vehicle 102 to warn of this condition. Similarly, even when vehicle 302 is not decelerating, but the distance between intelligent vehicle 102 and vehicle 302 is decreasing, the intelligent vehicle 102 can detect the change in distance (e.g., via the sensor array 108) and alert a user of intelligent vehicle 102.

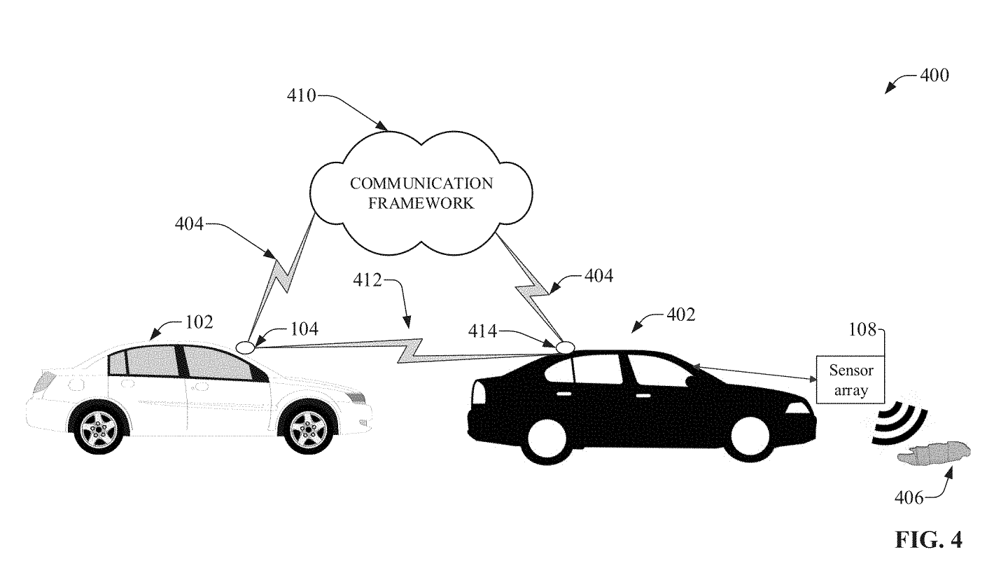

FIG. 4 illustrates a diagram of an example, non-limiting scenario 400 in which the intelligent vehicle 102 and a second intelligent vehicle 402 can be in communication with each other in accordance with one or more embodiments described herein. Repetitive description of like elements employed in other embodiments described herein is omitted for sake of brevity. In scenario 400, intelligent vehicle 102 can be trailing the second intelligent vehicle 402. A condition of the roadway can exist in front of second intelligent vehicle 402. In this non-limiting example, that condition is represented by pothole 406. In one or more embodiments, the second intelligent vehicle 402 can comprise components equivalent to the components of the intelligent vehicle 102 and/or perform functions equivalent to function of the intelligent vehicle 102, as described herein.

In various embodiment, the intelligent vehicle 102 can be in direct communication 412 with the second intelligent vehicle 402. Direct communication 412 can comprise, but is not limited to: IR, shortwave transmission, NFC, Bluetooth, Wifi, LTE, GSM, CDMA, satellite, visual cues, radio signals, a combination thereof, and/or the like. Direct communication 412 can be established between the communications interface 104 of the intelligent vehicle 102 and a similar communications interface 414 of the second intelligent vehicle 402. The placement of communications interface 104 and communications interface 414 can be anywhere on and/or in either respective vehicle (e.g., the intelligent vehicle 102 and/or the second intelligent vehicle 402).

In scenario 400, the second intelligent vehicle 402 can be ahead of the intelligent vehicle along the roadway and/or can detect one or more potholes 406 (e.g., via at least a sensor array 108). The one or more potholes 406 can be representative of a road condition and is not limited to a pothole. In addition to a user of second intelligent vehicle 402 receiving alerts for the road condition (e.g., pothole 406), the second intelligent vehicle 402 can send a direct communication 412 to the intelligent vehicle 102 (e.g., instructed by a controller 106 of the second intelligent vehicle 402), which can comprise a message that the road condition is ahead. The message can be processed by controller 106 of the intelligent vehicle 102. After processing, the intelligent vehicle 102 can issue an alert to a user of the intelligent vehicle 102 via at least one of a plurality of interface devices (e.g., comprising the frontal interior 200).

In one or more embodiments, the intelligent vehicle 102 can be in indirect communication with second intelligent vehicle 402. Indirect communication can comprise, but is not limited to: a wireless communication 404 and/or a communication framework 410. Wireless communication 404 can comprise, but is not limited to: IR, shortwave transmission, NFC, Bluetooth, Wifi, LTE, GSM, CDMA, satellite, visual cues, radio signals, a combination, thereof, and/or the like. Communication framework 410 can comprise, but is not limited to: a global communication network such as the Internet that can be employed to facilitate communications between intelligent vehicles. Indirect communication can be established between communications interface 104 of the intelligent vehicle 102 and a similar communications interface 414 of the second intelligent vehicle 402 via wireless communication 404 and/or the communication framework 410. The placement of communications interface 104 and communications interface 414 can be anywhere on and/or in either respective vehicle (e.g., intelligent vehicle 102 and/or second intelligent vehicle 402).

In scenario 400, the second intelligent vehicle 402 can be ahead of the intelligent vehicle along the roadway and/or can detect one or more potholes 406 (e.g., via at least a sensor array 108). The one or more potholes 406 can be representative of a road condition and is not limited to a pothole. In addition to a user of second intelligent vehicle 402 receiving alerts for the road condition (e.g., pothole 406), the second intelligent vehicle 402 can send an indirect communication (e.g., via the communication framework 410) to the intelligent vehicle 102 (e.g., instructed by a controller 106 of the second intelligent vehicle 402), which can comprise a message that the road condition is ahead. The message can be processed by controller 106 of the intelligent vehicle 102. After processing, the intelligent vehicle 102 can issue an alert to a user of the intelligent vehicle 102 via at least one of a plurality of interface devices (e.g., comprising the frontal interior 200).

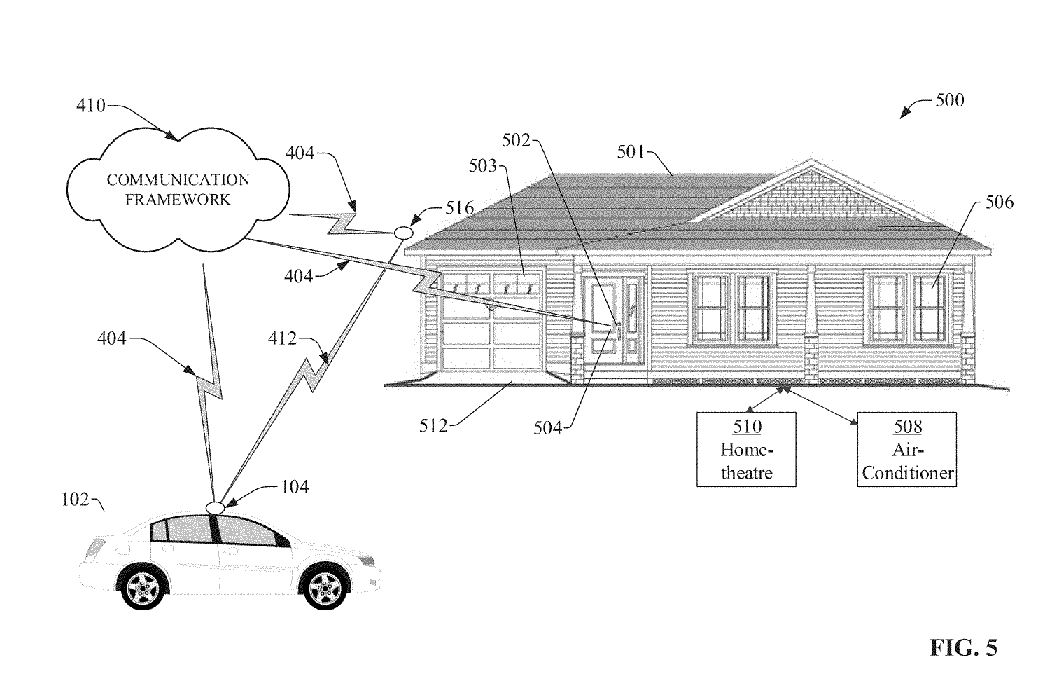

FIG. 5 illustrates a diagram of an example, non-limiting scenario 500 in which intelligent vehicle 102 and an intelligent building 501 (e.g., a residence) can be in communication with each other in accordance with one or more embodiments described herein. Repetitive description of like elements employed in other embodiments described herein is omitted for sake of brevity.

The intelligent building 501 can comprises a processor operably coupled to one or more connected devices, not limited to: door locks, garage door, lights, home theatre, air conditioning, heating, thermostat, window blinds, windows, solar devices, swimming pool operation devices, hot tub operation devices, kitchen appliances, cameras, baby monitors, video games, computers, mobile devices, a combination thereof, and/or the like. The connected devices can be coupled to the intelligent building 501 via a communication framework 410. The connection/coupling can be wired or wireless. The intelligent building 501 can have a communications interface 516 to facilitate connection to devices, and/or devices of the intelligent building 501 can connect directly to the communication framework 410 via a wired or wireless connection without the need for a communications interface 516 and/or a controller 106. The intelligent vehicle 102 can communicate with the intelligent building 501 acting as a hub via a communications framework 410 and/or communications interface 516, and/or directly with the devices of the intelligent building 501 via wireless communication. The communications framework 410 can also interface directly with devices of the intelligent building 501, allowing for the intelligent vehicle 102 to connect to the devices of the intelligent building 501 through the communication framework 410 without needing a communications interface 516.

In one or more embodiments, as the intelligent vehicle 102 approaches the intelligent building 501, the controller 106 of intelligent vehicle 102 can send a signal (e.g., via communications interface 104) through the communication framework 410 (e.g., via wireless communication 404) to communications interface 516 of the intelligent building 501. Communications interface 516 can be coupled to one or more devices of the intelligent building 501 and can send the devices a signal. The devices can respond in accordance with a method set by a user of the intelligent vehicle 102 and/or the intelligent building 501. For example, a proximity status of the intelligent vehicle 102 to the intelligent building can cause a lock 502 of the intelligent building 501 to unlock or unlock. In another example, an air conditioner 508 of the intelligent building 501 (via a thermostat) can adjust the temperature setting of the intelligent building 501 in response to the proximity of intelligent vehicle 102. Other devices can react in an autonomous or predetermined fashion in response to the proximity of intelligent vehicle 102 respective to the device's capabilities, such as one or more windows 506 of the intelligent building 501 opening or closing, one or more blinds opening or closing, a home theatre 510 of the intelligent building 501 transferring music, a garage 503 of the intelligent building 501 opening or closing, a combination thereof, and/or the like.

In one or more embodiments, as the intelligent vehicle 102 approaches the intelligent building 501, the controller 106 of intelligent vehicle 102 can send a signal (e.g., via communications interface 104) through the communication framework 410 (e.g., via wireless communication) directly to devices of the intelligent building 501. One or more devices of the intelligent building 501 can also be coupled to the communication framework 410. The devices can respond in accordance with a method set by a user of the intelligent vehicle 102 and/or the intelligent building 501. For example, the proximity status of the intelligent vehicle 102 to the intelligent building 501 can cause lock 502 to unlock or unlock. In another example, the air conditioner 508 (e.g., via a thermostat) can adjust the temperature setting of the intelligent building 501 in response to the proximity of intelligent vehicle 102. Other devices can react in an autonomous or predetermined fashion in response to the proximity of intelligent vehicle 102 respective to the device's capabilities, such as windows 506 opening or closing, blinds opening or closing, home theatre 510 transferring music and garage 503 opening or closing, a combination thereof, and/or the like.

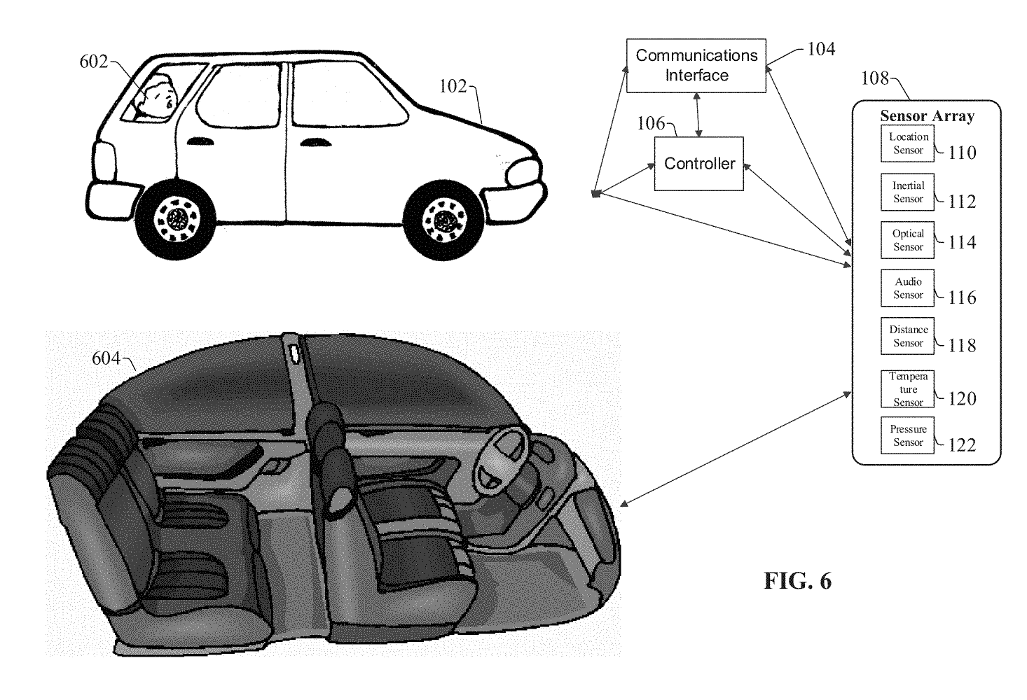

FIG. 6 illustrates a diagram of an example, a non-limiting interior 604 of intelligent vehicle 102 in accordance with one or more embodiments described herein. Repetitive description of like elements employed in other embodiments described herein is omitted for sake of brevity. The interior 604 can comprise the sensor array 108, the communications interface 104, the frontal interior 200, and/or the controller 106. An entity 602 (e.g., an individual) can be located inside the intelligent vehicle 102 and/or the interior 604. Example entities 602 can include, but are not limited to: a child, a pet, incapacitated person, a combination thereof, and/or the like. In one or more embodiments, the controller 106 can detect the entity 602 and/or determine a status of the entity 602 by receiving an input from the sensor array 108. Further, the controller 106 can instruct the communications interface 104, the display 204, the screen 202, and/or the HUD 212 to display and/or otherwise convey an alert (e.g., a message) regarding the determined existence and/or status of the entity 602.

For example, the intelligent vehicle 102 (e.g., via the controller 106 and/or the sensor array 108) can detect the existence and/or status of one or more entities located throughout the intelligent vehicle 102. For instance, the one or more entities 602 can be detected by the intelligent vehicle 102 within any portion of the interior 604 (e.g., a trunk space). The presence of an entity 602 can be detected, for example, by the sensor array 108 (e.g., the inertial sensor 112) based on movement of the entity within the intelligent vehicle 102 (e.g., by detecting if intelligent vehicle 102 moves in any respect or vibrates in any respect as a result of movement from the entity 602 among other methods).

In another example, the optical sensor 114 can capture visual (e.g., imaging) data regarding the one or more entities 602 within the intelligent vehicle 102. Also, an alert (e.g., generated by the controller 106) can be further activated in response to detecting the entity 602. Additionally, photographic and/or video data can be captured and/or stored in a memory operatively coupled to the intelligent vehicle 102 in response to a detection of an entity 602 in the intelligent vehicle 102 and/or the interior 604. Moreover, the optical sensor 114 can also visualize an absence of occupation of the interior 604 and/or the intelligent vehicle 102 to prevent an alarm from being triggered.

In a further example, the audio sensor 116 can capture sound data regarding one or more entities 602 within the intelligent vehicle 102. The audio sensor 116 can listen for breathing and/or some other evidence that a living-being is present inside the intelligent vehicle 102. For instance, the audio sensor 116 can detect labored breathing and/or an absence of breathing after an entity 602 has already been detected by the sensor array 108 (e.g., another respective sensor), thereby indicating a situation in which the entity 602 may needs immediate attention.

In another example, the distance sensor 118 can detect movement of one or more entities 602 within intelligent vehicle 102. The distance sensor 118 can also compare sensory readings of the interior 604 with sensory readings from a known unoccupied state of the interior 604. Additionally, the temperature sensor 120 can detect temperature readings from the interior 604 of intelligent vehicle 102. Based on the data collected by the temperature sensor 120, the controller 106 can determine whether the interior 604 is at a safe or dangerous temperature with respect to an entity 602 being inside the interior 604. Furthermore, the temperature sensor 120 (e.g., a thermal imaging camera) can also detect the temperature of entities 602 within the intelligent vehicle 102. The detection of a temperature of an entity 602 can indicate the presence and/or status of the entity 602.

In a further example, the pressure sensor 122 can detect changes in pressure in the interior 604 of intelligent vehicle 102. Pressure sensor 122 can be in a plurality of locations within intelligent vehicle 102 for the purpose of detecting pressure, including, but not limited to: the floor, seats, the trunk, a combination thereof, and/or the like. Pressure sensor 122 can detect the movement from one area of interior 604 to another, such as a pet moving about the intelligent vehicle 102 and/or a child moving about the intelligent vehicle 102. The pressure sensor 122 can also detect a lack of movement of the entity 602.

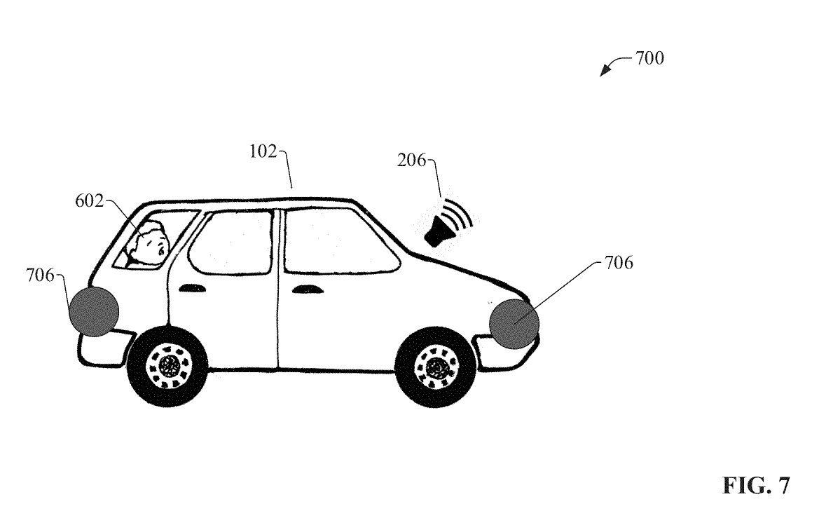

FIG. 7 illustrates a diagram of an example, non-limiting scenario 700 of intelligent vehicle 102 occupied by one or more entities 602 in accordance with one or more embodiments described herein. Repetitive description of like elements employed in other embodiments described herein is omitted for sake of brevity. The intelligent vehicle 102 can determine (e.g., via the sensor array 108, the communications interface 104, and/or the controller 106) that an alarm needs to be generated and/or presented as a result of the occupation of the one or more entities 602 within intelligent vehicle 102. In response, the intelligent vehicle 102 can generate and/or present the alarm at the location of intelligent vehicle 102.

For example, the intelligent vehicle 102 can create a sound via the one or more speakers 206 and/or enable/flash one or more lights 706. The one or more speakers 206 can create an audible tone for the purpose of alerting individuals nearby intelligent vehicle 102 that there is a problem which requires attention. Similarly, the one or more lights 706 can flash to create a visual distress signal for the purpose of alerting individuals nearby intelligent vehicle 102 that there is a problem which requires attention.

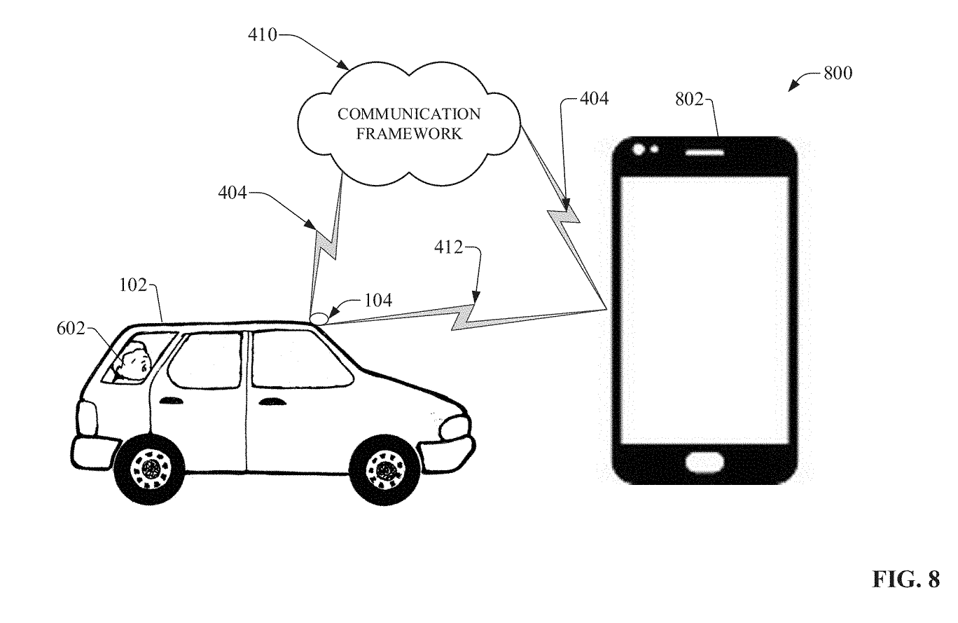

FIG. 8 illustrates a diagram of an example, non-limiting scenario 800 of intelligent vehicle 102 occupied by one or more entities 602 in accordance with one or more embodiments described herein. Repetitive description of like elements employed in other embodiments described herein is omitted for sake of brevity. The intelligent vehicle 102 can determine (e.g., through the sensor array 108, the communications interface 104, and/or the controller 106) that a message needs to be generated and/or presented as a result of the occupation of one or more entities 602 within intelligent vehicle 102. In response, the intelligent vehicle 102 can generate and/or present the message of the detection to a device 802 through a communications framework 410 (e.g., via a communications interface 104 and/or wireless communication 404). The intelligent vehicle 102 can also send a message of the detection to a device 802 directly via communications interface 104 and/or wireless communication. The device 802 can be one of a plurality of types of devices including, but not limited to: a smartphone, a cellphone, a smart watch, a PDA, a pager, a laptop computer, a desktop computer, a tablet, a combination thereof, and/or the like.

In one or more embodiments, the device 802 can be connected directly to intelligent vehicle 102 via wireless communication (e.g., communication framework 410) and/or communications interface 104. In the event that a message is to be sent to device 800 (e.g., as a result of a detection of a condition through sensor array 108, the communications interface 104 and/or controller 106), the intelligent vehicle 102 can directly send the message to device 802 indicating a condition that triggered the generation of the message (e.g., the presence of the entity 602 remaining inside the intelligent vehicle 102). Device 802 can also access information from the intelligent vehicle 102 from the sensor array 108 and/or internal vehicle computers.

In one or more embodiments, the device 802 can be connected indirectly to intelligent vehicle 102 via wireless communication 404, communications interface 104, and/or communications framework 410. In the event that a message is to be sent to the device 802 (e.g., as a result of the detection of a condition through sensor array 108, communications interface 104, and/or controller 106), the intelligent vehicle 102 can indirectly send the message to the device 802 through communication framework 410 indicating a condition such as an entity 602 remaining inside intelligent vehicle 102. Device 802 can also access information from intelligent vehicle 102 from the sensor array 108 and/or internal vehicle computers.

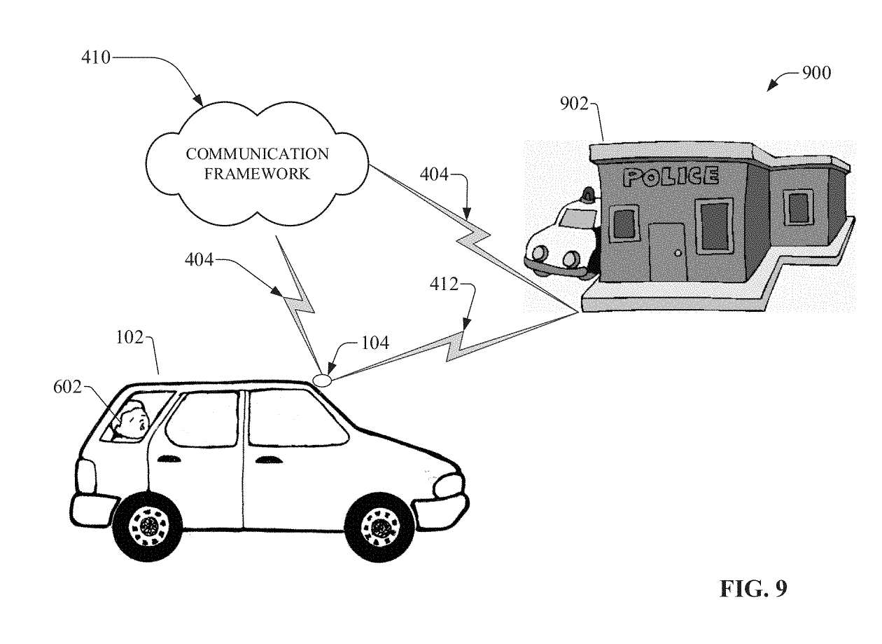

FIG. 9 illustrates a diagram of an example, non-limiting scenario 900 of the intelligent vehicle 102 occupied by one or more entities 602 in accordance with one or more embodiments described herein. Repetitive description of like elements employed in other embodiments described herein is omitted for sake of brevity. The intelligent vehicle can determine (e.g., through the sensor array 108, communications interface 104, and/or the controller 106) that a message needs to be sent as a result of the occupation of the entity 602 within intelligent vehicle 102. In response, the intelligent vehicle 102 can send the message of the detection to an emergency system (e.g., law enforcement agency 902) through a communications framework 410 via a communications interface 104 via wireless communication 404. Intelligent vehicle 102 can also send the message regarding the determined detection to the law enforcement agency 902 directly via communications interface 104 and/or wireless communications (e.g. communication framework 410).

In one or more embodiments, the law enforcement agency 902 can be connected directly to the intelligent vehicle 102 via wireless communication, and/or communications interface 104. In the event that a message is to be sent to law enforcement agency 902 (e.g., as a result of the detection of a condition through sensor array 108, communications interface 104 and/or controller 106), the intelligent vehicle 102 can directly send the message to law enforcement agency 902 indicating the condition (e.g., such as an entity 602 remaining inside the intelligent vehicle 102).

In one or more embodiments, the law enforcement agency 902 can be connected indirectly to intelligent vehicle 102 via wireless communication 404, communications interface 104, and/or communications framework 410. In the event that a message is to be sent to the law enforcement agency 902 (e.g., as a result of the detection of a condition through sensor array 108, communications interface 104, and/or controller 106), the intelligent vehicle 102 can indirectly send a message to law enforcement agency 902 through communication framework 410 indicating the condition (e.g., such as an entity 602 remaining inside intelligent vehicle 102).

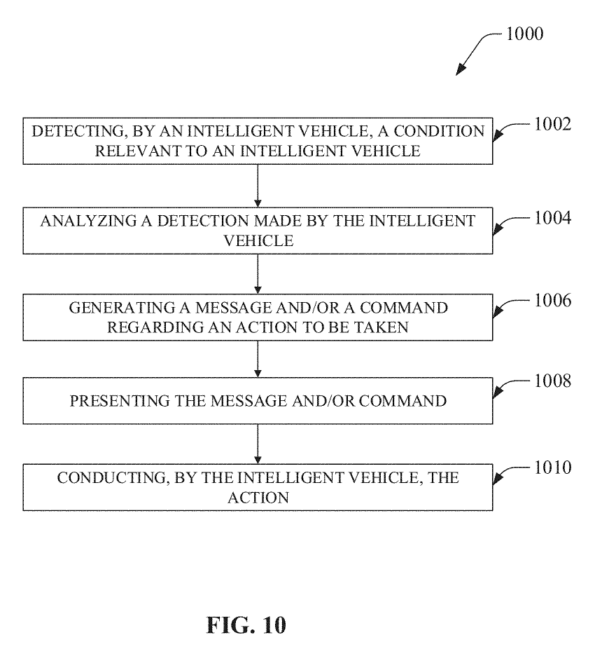

FIG. 10 illustrates a flow diagram of an example, non-limiting method 1000 that can facilitate detecting a condition and ultimately executing an action via an intelligent vehicle 102 (e.g., a controller 106) in accordance with one or more embodiments described herein. Repetitive description of like elements employed in other embodiments described herein is omitted for sake of brevity.

At 1002, the method 1000 can comprise detecting, by an intelligent vehicle 102 (e.g., via the sensor array 108), one or more conditions relevant to the intelligent vehicle 102, which can be one of a plurality of conditions, both interior and/or exterior to the intelligent vehicle 102. Example conditions that can be detected at 1002 can include, but are not limited to: an entity 602 located (e.g., trapped) within the intelligent vehicle 102, a road condition (e.g., such as a pothole 406), an arrival at a destination, a presence of another vehicle (e.g., second intelligent vehicle 402), conditions relating to another vehicle (e.g., second intelligent vehicle 402), a combination thereof, and/or the like.

At 1004, the method 1000 can comprise analyzing (e.g., via the controller 106) one or more detections made at 1002 (e.g., data collected by the sensor array 108). For example, exterior and/or interior conditions can be analyzed and compared to value thresholds in order to determine whether the detected conditions are acceptable or unacceptable. These thresholds can be preconfigured and/or set by a user of the intelligent vehicle 102.

At 1006, the method 1000 can comprise generating (e.g., via the controller 106) a message and/or command regarding an action to be taken (e.g., by a user of the intelligent vehicle 102, by an entity 602, by an intelligent building 501, and/or by a law enforcement agency 902). For example, the message and/or command can alert a user of the intelligent vehicle 102 that an action will be taken.

At 1008, the method 1000 can comprise presenting (e.g., via the display 204, the screen 202, the HUD 212, other various components of the frontal interior 200, a combination thereof, and/or the like) the message and/or command generated at 1006. The message and/or command can be presented (e.g., visually, hepatically, and/or audibly) in a plurality of locations, for example, but not limited to: the intelligent vehicle's 102 displays (e.g., display 204, screen 202, and/or HUD 212), the intelligent vehicle's 102 speakers 206, smartphones and/or other connected devices, a combination thereof, and/or the like.

At 1010, the method 1000 can comprise conducting an action by the intelligent vehicle 102. The action can be at least one of a plurality of actions. For example, the action can include unlocking a door, opening a door, closing a door, opening a trunk, closing a trunk, rolling down a window, closing a window, opening a sunroof, closing a sunroof, engaging air conditioning, engaging heater, shutting engine off, turning engine on, applying vehicle brakes, sending a signal to an external device (e.g., device 802), sending a signal to a law enforcement agency 902, a combination thereof, and/or the like. For instance, the action can regarding manipulating and/or otherwise controlling one or more features of an intelligent building 501.

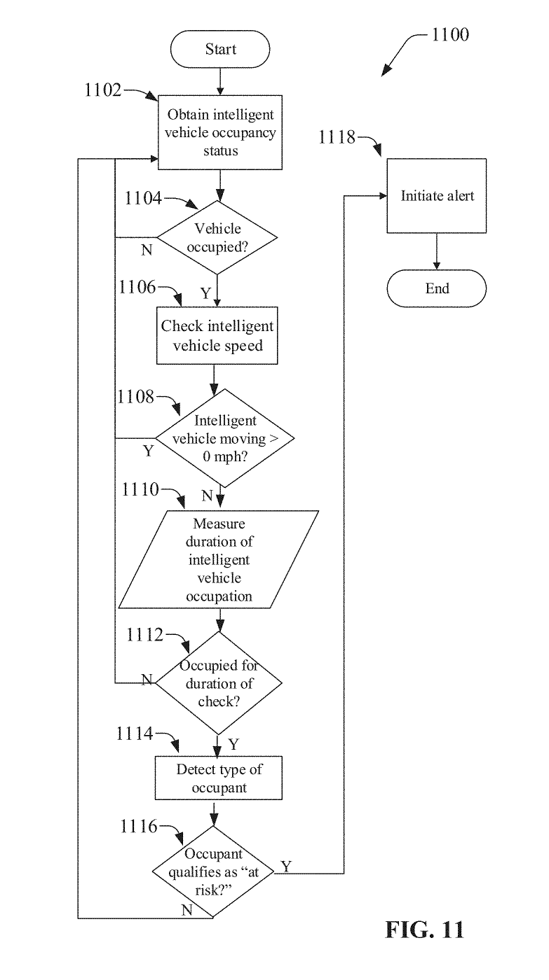

FIG. 11 illustrates a flow diagram of example, non-limiting operations 1100 that can be executed by the intelligent vehicle 102 regarding the detection of an entity 602 and/or the generation and/or presentation of an alert in accordance with one or more embodiments described herein. Repetitive description of like elements employed in other embodiments described herein is omitted for sake of brevity.

At 1102, the operations 1100 can comprise collecting data regarding an occupancy status (e.g., via the sensor array 108) of the intelligent vehicle 102. The occupancy status can include, but is not limited to: the presence of an entity 602 such as a pet, child or incapacitated adult inside of an intelligent vehicle 102. At 1104, the operations 1100 can comprise determining (e.g., via the controller 106), based on the collected data of 1102, the occupancy status of the intelligent vehicle 102. If not occupied, the intelligent vehicle 102 can continue to collect data as described in regards with 1102.

If occupied, the operations 1100 of the intelligent vehicle 102 can continue to 1106, wherein the intelligent vehicle 102 can collect data regarding a speed at which the intelligent vehicle 102 is travelling. The speed can refer to a speed relative to ground. At 1108, the operations 1100 can comprise determining (e.g., via the controller 106 and/or the sensor array 108) whether the intelligent vehicle 102 is in motion. If the intelligent vehicle 102 is in motion, the intelligent vehicle 102 can continue to collect data as described in regards with 1102.

If the intelligent vehicle 102 is not in motion, the operations of the intelligent vehicle 102 can continue to 1110, wherein the intelligent vehicle 102 can measure (e.g., via the controller 106 and/or the sensor array 108) the length of occupation of the intelligent vehicle 102. The amount of time set to elapse can be predetermined. For example, the amount of time can be two minutes of continuous checking for occupation. At 1112, the operations 1100 can comprise determining (e.g., via the controller 106 and/or the sensor array 108) whether the intelligent vehicle 102 was occupied for the entire duration of the check, in this case, for two minutes. If the intelligent vehicle 102 was not occupied for the entire duration of the check, the intelligent vehicle 102 can continue to collect data as described in regards with 1102.

If the intelligent vehicle 102 was occupied for the entire duration of the check, the operations 1100 of the intelligent vehicle 102 can continue to 1114, wherein the operations 11000 can comprise detecting the type of entity 602 detected. For example, the intelligent vehicle 102 (e.g., via the controller 106 and/or the sensor array 108) can determine whether the entity 602 is one of, but not limited to: an inanimate object, a pet, a child, an incapacitated adult, or other. The detection can occur through at least one sensor from the sensor array 108. At 1116, the operations 1100 can comprise determining (e.g., via the controller 106) whether one or more of the detected entities 602 are at risk. For example, the intelligent vehicle 102 can determine whether the detected entity 602 qualifies as “at risk” by cross referencing the entity 602 type with a list of entity 602 types carrying either an “at risk” designation or not “at risk” designation. “At risk” can refer to, but is not limited to: a life form that may not be able to help itself in a situation such as exiting the intelligent vehicle 102. If the entity 602 is not at risk, the intelligent vehicle 102 can continue to collect data as described in regards with 1102.

If the entity 602 is at risk, the operations 1100 of the intelligent vehicle 102 can continue to 1118, which can comprise generating (e.g., via the controller 106) and/or sending (e.g., via communications interface 104) an alert to a plurality of locations, including, but not limited to: a smart phone, an intelligent building 501, devices of an intelligent building 501, a computer, a tablet, another intelligent vehicle 102 (e.g., second intelligent vehicle 402), a law enforcement agency 902, a text message, an email, a combination thereof, and/or the like. The alert can also be observed at the location of the intelligent vehicle 102 (e.g., via the frontal interior 200), such as via a siren and/or flashing lights. The operations 1100 can be continuously executed after initiating the alert.

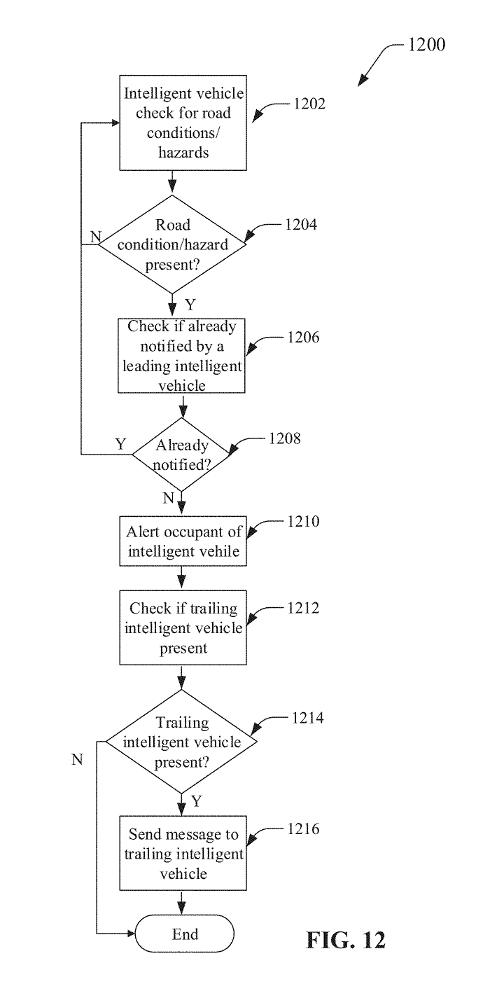

FIG. 12 illustrates a flow diagram of example, non-limiting operations 1200 that can be performed by the intelligent vehicle 102 to generate and/or present one or more alerts regarding one or more detected road conditions in accordance with one or more embodiments described herein. Repetitive description of like elements employed in other embodiments described herein is omitted for sake of brevity.

At 1202, the operations 1200 can comprise collecting data (e.g., via the sensor array 108 and/or communications interface 104) regarding road conditions and/or possible hazards, such as, but not limited to: potholes, road debris, disabled vehicles, life forms on the roadway, animals, road obstructions, items/situations that can be harmful/destructive to the intelligent vehicle 102, a combination thereof, and/or the like. For example, the intelligent vehicle 102 can checks for these occurrences via one or more sensor arrays 108.

At 1204, the operations 1200 can comprise determining (e.g., via the controller 106) whether a road condition/hazard exists in the path of the intelligent vehicle 102 within a distance predetermined or set by a user of the intelligent vehicle 102. If a condition/hazard is not present, the intelligent vehicle 102 can continue to collect data as described in regards with 1202. If a condition/hazard is present, the operations 1200 of the intelligent vehicle 102 can continue to 1206.

At 1206, the operations 1200 can comprise checking (e.g., via the controller 106) whether the intelligent vehicle 102 was already notified of the detected condition (e.g., by a leading intelligent vehicle 102). For example, a notification can be received via a wireless transmission from a proximal leading or trailing second intelligent vehicle 402. At 1208, the operations 1200 can return to 1202 if the notification from a second intelligent vehicle 402 was already received. Alternatively, at 1208 the operations 1200 can continues to 1210 if the notification has not been received.

At 1210, the operations 1200 can comprise alerting an occupant/user of the intelligent vehicle 102 of the detected road condition. The alert can be sent to a plurality of locations, including, but not limited to: a smart phone, an intelligent building 501, one or more devices connected to an intelligent building 501, a computer, a tablet, a second intelligent vehicle 402, a law enforcement agency 902, a text message, an email, a combination thereof, and/or the like. The alert can also be presented to the occupant/user at the location of the intelligent vehicle 102, such as via a siren and/or flashing lights.

At 1212, the operations 1200 can comprise determining (e.g., via the controller 106) whether another intelligent vehicle 102 (e.g., a second intelligent vehicle 402 trailing the intelligent vehicle 102) is within a predetermined proximity to the intelligent vehicle 102. This can be achieved through the sensor array 108 and/or communications interface 104 coupled to the intelligent vehicle 102. At 1214, the operations 1200 can be complete if another intelligent vehicle 102 (e.g., a trailing intelligent vehicle 102) is not within the predetermined proximity. Alternatively, the operations 1200 can continues to 1216 if another intelligent vehicle 102 (e.g., a trailing intelligent vehicle 102) is within the predetermined proximity. At 1216, the operations 1200 can comprise generating and/or sending (e.g., via the controller 106 and/or the communications interface 104) a message and/or an alert to a second intelligent vehicle 402 (e.g., a trailing intelligent vehicle 102 within the predetermined proximity), wherein the message and/or alert can regard a warning that the intelligent vehicle 102 has encountered a condition/hazard on the roadway. The operations 1200 can be executed continuously after sending a message to a trailing intelligent vehicle 102.

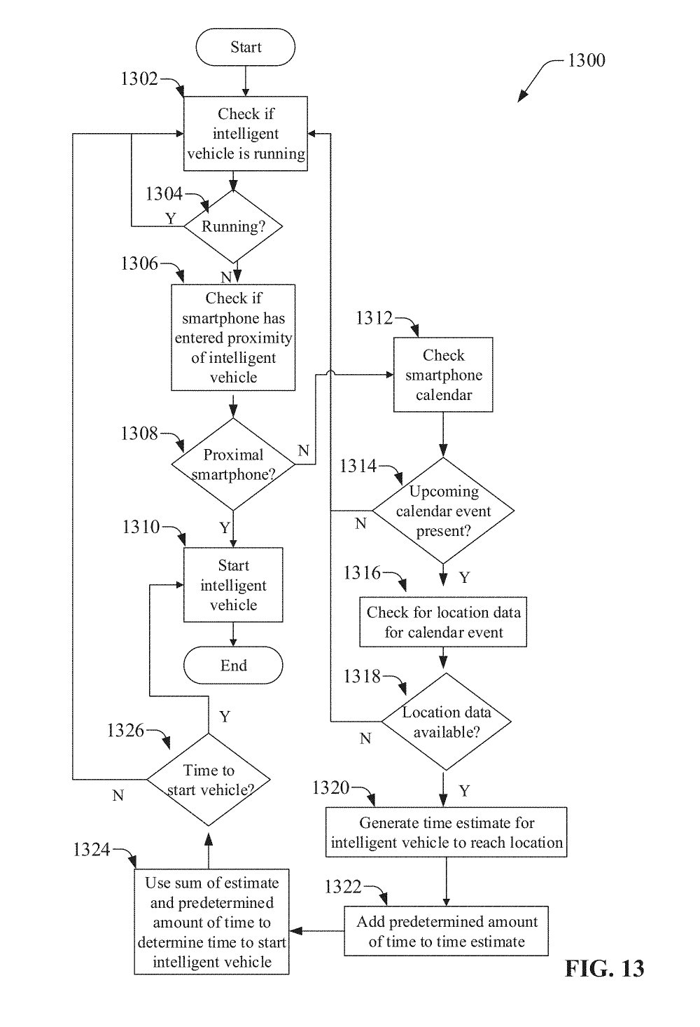

FIG. 13 illustrates a diagram of example, non-limiting operations 1300 that can facilitate an intelligent vehicle 102 in starting itself in accordance with one or more embodiments described herein. Repetitive description of like elements employed in other embodiments described herein is omitted for sake of brevity.

At 1302, the operations 1300 can comprise determining (e.g., via the controller 106 and/or the sensor array 108) whether the subject intelligent vehicle 102 is on or off (e.g., whether an engine of the intelligent vehicle 102 is operating or not operating). For example, the intelligent vehicle 102 can be determined to be running based on a sense of physical movement of an engine with respect to an internal combustion engine, or activated with respect to an electric vehicle or other form of propulsion that does not require significant power consumption to be in a run state.

At 1304, if the intelligent vehicle 102 is determined not to be running at 1302, the operations 1300 can continue to 1306. At 1306, the operations 1300 can comprise determining whether a smartphone registered with the intelligent vehicle 102 is within a defined proximity to the intelligent vehicle 102. At 1308, if a registered smartphone is within the proximity, as determined at 1306, the operations 1300 can continue to 1310. Alternatively, at 1308 if a registered smartphone is not within the proximity, as determined at 1306, the operations 1300 can continue to 1312.

At 1310, the operations 1300 can comprise activating (e.g., via the controller 106) the intelligent vehicle 102 to achieve a run state. At 1312, the operations 1300 can comprise retrieving a calendar from the registered smartphone that is proximity to the intelligent vehicle 102. Additionally, the calendar can also reside on a different device of which the intelligent vehicle 102 can access.

At 1314, the operations 1300 can comprise determining (e.g., via the controller 106) whether an event is upcoming in the calendar. A length of time defining “upcoming” can be preset or user-set by a user of the intelligent vehicle 102. If an upcoming calendar event does not exist, the operations 1300 can repeat back to 1302. If an upcoming calendar event does exist, the operations 1300 can continue to 1316. At 1316, the operations 1300 can determine (e.g., via the controller 106) whether there exists location data for the location of the upcoming calendar event. For example, the location data can be compared (e.g., via the controller 106) to the current location of the intelligent vehicle 102 and, combined with traffic and road condition information, generate an estimated length of travel to reach the location of the upcoming calendar event.

At 1318, the operations 1300 can return to 1302 if no location information is available, and proceeds to 1320 if location data for the calendar event is available. At 1320, the operations 1300 can comprise generating (e.g., via the controller 106) a time estimate for how much time it will take for the intelligent vehicle 102 to reach the upcoming calendar event location. The location data can be compared to the current location of the intelligent vehicle 102 and combined with traffic and road condition information to generate an estimated length of travel to reach the location of the upcoming calendar event.

At 1322, the operations 1300 can comprise adding (e.g., via the controller 106) a predetermined amount of time to the estimate generated at 1320. The predetermined amount of time can be representative of the amount of time the intelligent vehicle 1022 is to be running prior to beginning to be navigated to the location of the upcoming calendar event. The amount of time can be preset or set by a user of the intelligent vehicle 102. At 1324, the operations 1300 can comprise converting (e.g., via the controller 106) the time sum from 1322 to a time of day to start the intelligent vehicle 102. The time of day is determined from the sum determined in 1322 and the time of the upcoming calendar event. At 1326, the operations 1300 can determine (e.g., via the controller 106) if the time to start the intelligent vehicle 102 has been reached. If it has not, the operations 1300 can return to 1302. If the time to start the intelligent vehicle 102 has been reached, the operations can proceed to 1310.

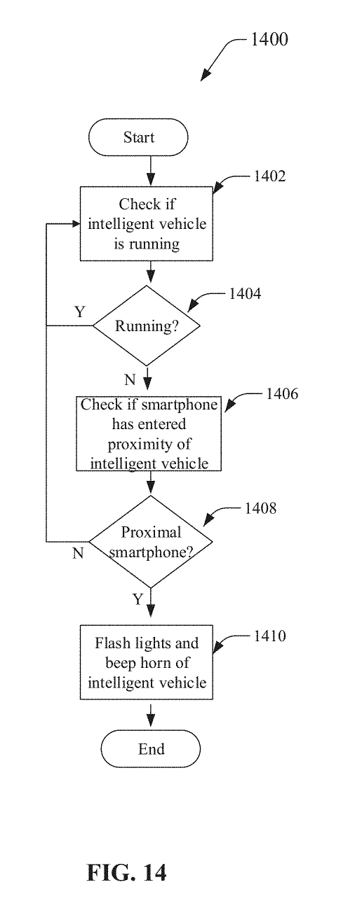

FIG. 14 illustrates a diagram of example, non-limiting operations 1400 associated with a situation in which an intelligent vehicle 102 can aid a user of the intelligent vehicle 102 in locating the intelligent vehicle 102 in accordance with one or more embodiments described herein. Repetitive description of like elements employed in other embodiments described herein is omitted for sake of brevity.

At 1402, the operations 1400 can determine (e.g., via the controller 106) whether the intelligent vehicle 102 is running (e.g., is turned on). Whether the intelligent vehicle 102 is running can be determined based on physical movement of an engine with respect to an internal combustion engine, and/or activated with respect to an electric vehicle or other form of propulsion that does not require significant power consumption to be in a run state.

At 1404, if the intelligent vehicle 102 is determined to be running, the operations 1400 can return to 1402. Alternatively, if the intelligent vehicle 102 is determined not to be running, the operations 1400 can continue to 1406. At 1406, the operations 1400 can comprise determining (e.g., via the controller 106) if a registered smartphone is within a predetermined proximity to the intelligent vehicle 102. At 1408, if a registered smartphone is not determined to be within the proximity, the operations 1400 can return to 1402. Alternatively, if a registered smartphone is determined to be within proximity to the intelligent vehicle 102, the operations 1400 can proceed to 1410. At 1410, the operations 1400 can comprise generating visual alerts (e.g., flashing lights) and/or audible alerts (e.g., sounds from a horn and/or siren) that can aid identify the intelligent vehicle 102. The operations 1400 can be continuously executed after initiating the visual and/or audible alerts.

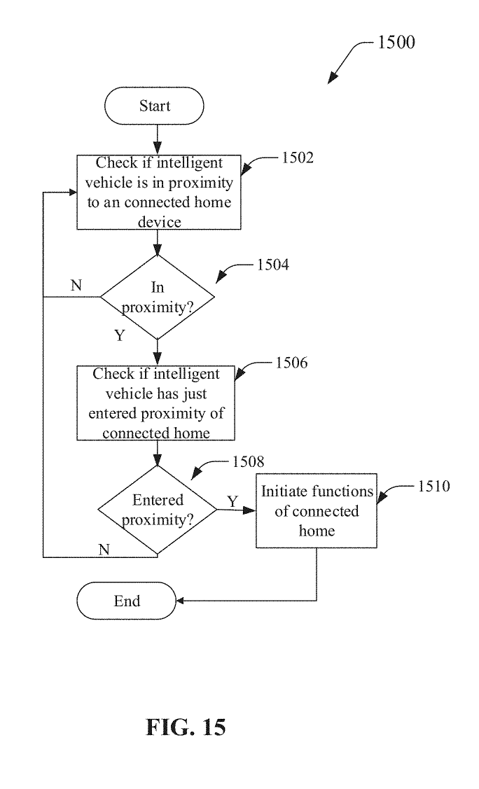

FIG. 15 illustrates a flow diagram of example, non-limiting operations 1500 that can facilitate controlling an intelligent building 501 via an intelligent vehicle 102 in accordance with one or more embodiments described herein. Repetitive description of like elements employed in other embodiments described herein is omitted for sake of brevity.

At 1502, the operations 1500 can comprise determining (e.g., via the controller 106, the sensor array 108, and/or the communications interface 104) whether the intelligent vehicle 102 is in present proximity to a connected device and/or intelligent building 501 associated with a user of the intelligent vehicle 102. A distance that defines a recognized proximity can be pre-configured or set by a user of the intelligent vehicle 102. At 1504, the operations 1500 can return to 1502 if the intelligent vehicle 102 is determined to not be in proximity. Alternatively, the operations 1500 continues to 1506 if the intelligent vehicle 102 is determined to be in proximity to a connected home/home device.

At 1506, the operations 1500 can comprise determining (e.g., via the controller 106 and/or the sensor array 108) whether the intelligent vehicle 102 was started within proximity of the connected device and/or intelligent building 501 or if the intelligent vehicle 102 entered proximity of the connected device and/or intelligent building 501 after it was started outside proximity to the device and/or intelligent building 501. At 1508, if the intelligent vehicle 102 did not enter proximity (e.g., the intelligent vehicle 102 was started within proximity), the operations 1500 can return to 1502. If it is determined that the intelligent vehicle 102 entered proximity of the connected device and/or intelligent building 501 after being started elsewhere, the operations 1500 can continue to 1510.

At 1510, the operations 1500 can comprise initiating (e.g., via the controller 106 and/or the communications interface 104) one or more functions of the subject device and/or intelligent building 501. Example functions can include, but not limited to: enabling and/or disabling air conditioning, garage door, home door locks and other connected features such as electronic window blinds, windows and others. For example, in one or more embodiments the intelligent vehicle 102 can automatically control lights of an intelligent building 501 (e.g., a home), disarm or arm a security system of an intelligent building 501 (e.g., a home security system), and/or control (e.g., set) a thermostat of an intelligent building 501 (e.g., a home thermostatO. The intelligent vehicle 102 can also alert one or more devices of a subject intelligent building 501 that the intelligent vehicle 102 has arrived within a predefined proximity to the intelligent building 501 (e.g., via geofence technologies). For example, the intelligent vehicle 102 can alert one or more occupants within an intelligent building 501 to come to the intelligent vehicle 102 to facilitate one or more tasks (e.g., unloading a truck, carrying groceries, a combination thereof, and/or the like).

One or more functions initiated at 1510 can be dependent upon preferences of a user of the intelligent vehicle 102 and/or the intelligent building 501 and can vary depending on the user. At 1510, automation of one or more of the functions, such as music transfer, can also occur. For example, a song, playlist, radio station or other music medium playing inside a subject intelligent building 501 can seamlessly transfer to the intelligent vehicle 102. The reverse can also occur, wherein a transfer from the intelligent vehicle 102 to the intelligent building 501 occurs. In another example, navigation instructions can be transferred from one or more devices associated with the intelligent building 501 (e.g., a computer device such as a home computer and/or a mobile device) automatically to the intelligent vehicle 102 (e.g., via the communications interface 104). In a further example, other media content (e.g., photos and/or videos) can also be transferred to and/or from the intelligent vehicle 102 to a subject intelligent building 501 and/or external device 802, such as a mobile device or home PC. Operations 1500 can be used for, but is not limited to: the transfer of movies, TV shows, pictures, for use on an infotainment system and dashboard camera recordings and capturing among other forms of digital content. The operations 1500 can be continuously executed after a transfer.

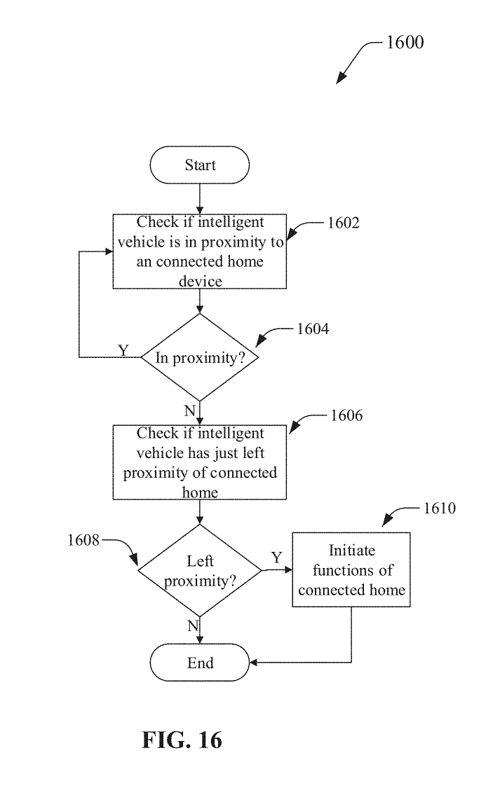

FIG. 16 illustrates a flow diagram of example, non-limiting operations 1600 that can facilitate an intelligent vehicle 102 in controlling one or more functions of a connected intelligent building 501 (e.g., a connected home). Repetitive description of like elements employed in other embodiments described herein is omitted for sake of brevity.

At 1602, the operations 1600 can comprise determining (e.g., via the controller 106, the sensor array 108, and/or the communications interface 106) whether the intelligent vehicle 102 is presently proximal to a connected intelligent building 501 and/or external device 802 associated with a user of the intelligent vehicle 102. The proximity determination at 1602 can be based on a distance that can be pre-configured or set by a user of the intelligent vehicle 102.

At 1604, the operations 1600 can comprise returning to 1602 in response to determining that the intelligent vehicle 102 is within the proximity parameter defined at 1602. Alternatively, the operations 1600 can comprise continuing to 1606 in response to determining that the intelligent vehicle 102 is not within the proximity parameter defined at 1602. At 1606, the operations 1600 can comprise determining (e.g., via the controller 106 and/or the sensor array 108) whether the intelligent vehicle 102 was started outside a proximity of a connect intelligent building 501 and/or device 802 or if the intelligent vehicle 102 left said proximity after being started within said proximity.

At 1608, the operations 1600 can comprise returning to 1602 in response to determining that the intelligent vehicle 102 was started outside the predefined proximity. Alternatively, the operations 1600 can comprise continuing to 1610 in response to determining that the intelligent vehicle 102 was started within the predefined proximity. At 1610, the operations can comprise initiating (e.g., via the controller 106 and/or the communications interface 104) one or more functions of a subject intelligent building 501 and/or external device 802. Example functions can include, but not limited to: enabling and/or disabling air conditioning for a subject intelligent building 501, opening and/or closing garage doors of a subject intelligent building 501, lock and/or unlock one or more electronic doors, window blinds, windows and the like, a combination thereof, and/or the like. For example, the intelligent vehicle 102 can automatically control lights of an intelligent building 501, disarm and/or arm an intelligent building's 501 security system, control an intelligent building's 501 thermostat, a combination thereof, and/or the like. In one or more examples, the intelligent vehicle 102 can alert an intelligent building 501 and/or external device 802 that the intelligent vehicle 102 has arrived, for instance, to alert occupants of the intelligent building 501 to come to the intelligent vehicle 102 to assist in various tasks.

In one or more embodiments, the functions can be dependent upon preferences of a user of the intelligent vehicle 102 and can vary depending on the user. For example, a song, playlist, radio station or other music medium playing inside a subject intelligent building 501 can seamlessly transfer to the intelligent vehicle 102. The reverse can also occur, wherein a transfer from the intelligent vehicle 102 to the intelligent building 501 occurs. In another example, navigation instructions can be transferred from one or more devices associated with the intelligent building 501 (e.g., a computer device such as a home computer and/or a mobile device) automatically to the intelligent vehicle 102 (e.g., via the communications interface 104). In a further example, other media content (e.g., photos and/or videos) can also be transferred to and/or from the intelligent vehicle 102 to a subject intelligent building 501 and/or external device 802, such as a mobile device or home PC. Operations 1600 can be used for, but is not limited to: the transfer of movies, TV shows, pictures, for use on an infotainment system and dashboard camera recordings and capturing among other forms of digital content. The operations 1600 can be continuously executed after a transfer.

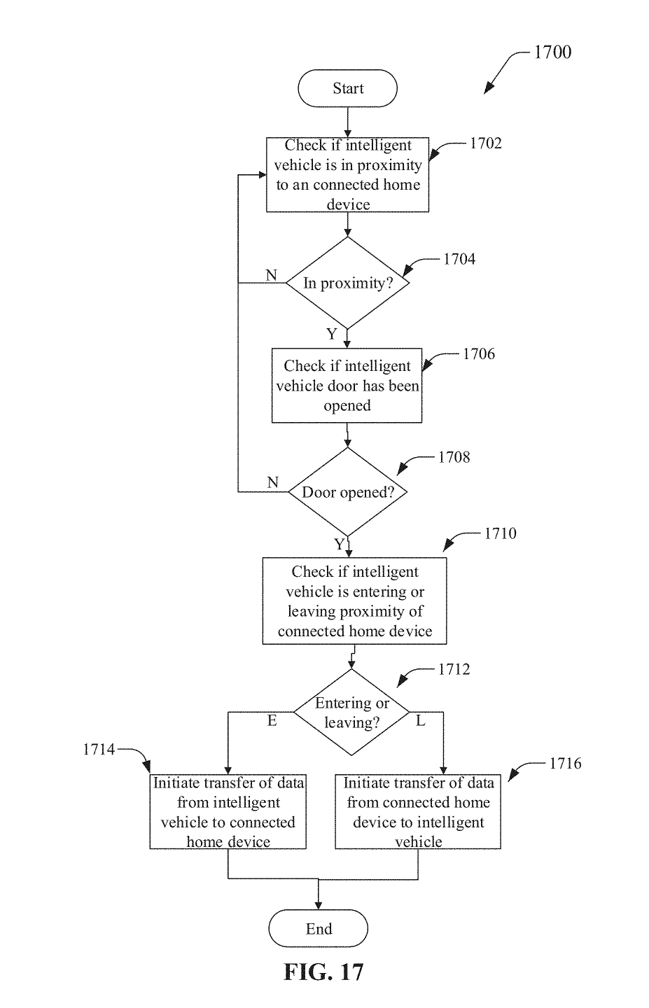

FIG. 17 illustrates a flow diagram of example, non-limiting operations 1700 that can facilitate a data transfer between an intelligent vehicle 102 and an intelligent building 501 and/or one or more external devices 802, in response to a door of the intelligent vehicle 102 being opened. Repetitive description of like elements employed in other embodiments described herein is omitted for sake of brevity.

At 1702, the operations 1700 can comprise determining (e.g., via the controller 106, the sensor array 108, and/or the communications interface 106) whether the intelligent vehicle 102 is presently proximal to a connected intelligent building 501 and/or external device 802 associated with a user of the intelligent vehicle 102. The proximity determination at 1702 can be based on a distance that can be pre-configured or set by a user of the intelligent vehicle 102.

At 1704, the operations 1700 can comprise returning to 1702 in response to determining that the intelligent vehicle 102 is not within the proximity parameter defined at 1702. Alternatively, the operations 1700 can comprise continuing to 1706 in response to determining that the intelligent vehicle 102 is within the proximity parameter defined at 1702.

At 1706, the operations 1700 can comprise determining whether one or more doors of the intelligent vehicle 102 has been opened. At 1708, if one or more doors have not been opened, the operations can return to 1702. Alternatively, if one or more doors have been opened, the operations 1700 can proceed to 1710. At 1710, the operations 1700 can comprise determining (e.g., via the controller 106 and/or the sensor array 108) whether the intelligent vehicle 102 is leaving proximity or entering proximity of a connected intelligent building 501 and/or an external device 802. For example, the operations 1700 can comprise determining (e.g., via the controller 106 and/or the sensor array 108) whether the intelligent vehicle 102 started running within proximity of the connected intelligent building 501 or if it started outside proximity. At 1712, in response to determining that the intelligent vehicle 102 is entering proximity of a connected intelligent building 501 and/or external device 802, the operations 1700 can proceed to 1714. In response to determining that the intelligent vehicle 102 is leaving proximity of a connected intelligent building 501 and/or external device 802, the operations 1700 can proceed to 1716.

At 1714, the operations 1700 can comprise transferring data from the intelligent vehicle 102 to a subject intelligent building 501 and/or external device 802. The transfer data can facilitate automation of one or more functions (e.g., functions comprising operations 1500 and/or 1600) such as music transfer. A song, playlist, radio station or other music medium can be playing inside the intelligent vehicle 102. The data (e.g., music) can seamlessly transfer to a connected intelligent building 501 and/or an external device 802. In one or more embodiments, the data can regard photos and videos can also be transferred from the intelligent vehicle 102 to an external device 802 such as a mobile device or home PC. The data transfer can facilitate, for example: the transfer of movies, TV shows, pictures, for use on an infotainment system and dashboard camera recordings and capturing among other forms of digital content.

At 1716, the operations 1700 can comprise transferring data from a subject intelligent building 501 and/or external device 802 to the intelligent vehicle 102. The transfer data can facilitate automation of one or more functions (e.g., functions comprising operations 1500 and/or 1600) such as music transfer. A song, playlist, radio station or other music medium can be playing inside the intelligent vehicle 102. The data (e.g., music) can seamlessly transfer to a connected intelligent building 501 and/or an external device 802. In one or more embodiments, the data can regard photos and videos can also be transferred from the intelligent vehicle 102 to an external device 802 such as a mobile device or home PC. The data transfer can facilitate, for example: the transfer of movies, TV shows, pictures, for use on an infotainment system and dashboard camera recordings and capturing among other forms of digital content

Additionally, the intelligent vehicle 102 can generate and/or send one or more alerts the intelligent building 501 and/or the external devices 802, which can indicate that the intelligent vehicle 102 has entered the defined proximity. For example, the one or more alerts can indicate to one or more occupants of the intelligent building 501 to come to the intelligent vehicle 102 to assist in one or more tasks. Functions that can be facilitated by the data transfer include, but not limited to: enabling and disabling air conditioning, garage door, home door locks and other connected features such as electronic window blinds, windows and others. Further, the intelligent vehicle 102 could automatically control lights of an intelligent building 501, disarm or arm an intelligent building's 501 security system, and/or set an intelligent building's 501 thermostat. The operations 1700 can be continuously executed after a transfer.

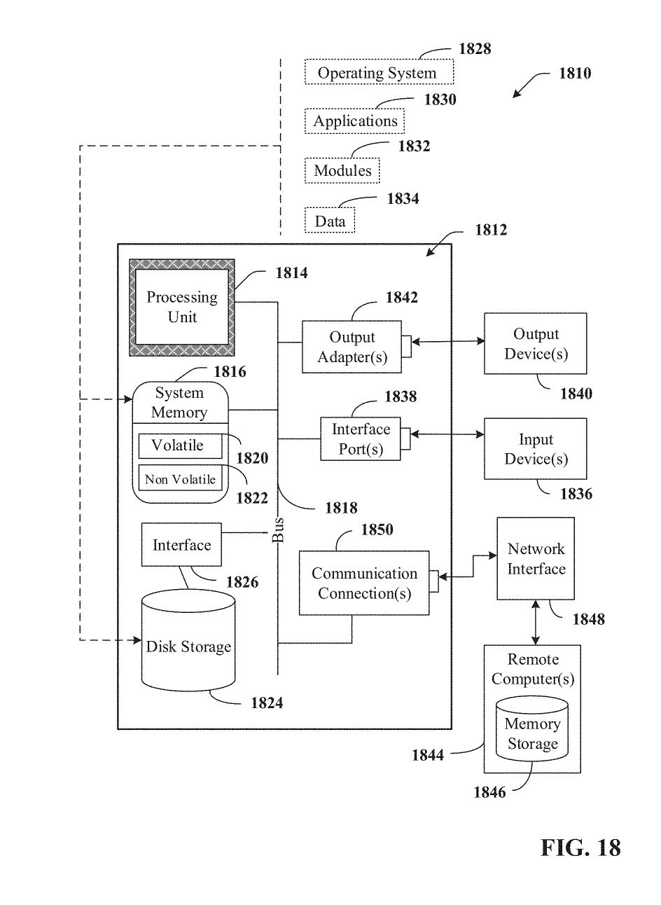

FIG. 18 illustrates a diagram of an example, non-limiting suitable environment 1810 for implementing various aspects of the claimed subject matter includes a computer 1812. Repetitive description of like elements employed in other embodiments described herein is omitted for sake of brevity. The computer 1812 includes a processing unit 1814, a system memory 1816, a codec 1815, and a system bus 1818. The system bus 1818 couples system components including, but not limited to, the system memory 1816 to the processing unit 1814. The processing unit 1814 can be any of various available processors. Dual microprocessors and other multiprocessor architectures also can be employed as the processing unit 1814.

The system bus 1818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1816 includes volatile memory 1820 and non-volatile memory 1822. The basic input/output system (BIOS), containing the basic routines to transfer information between elements within the computer 1812, such as during start-up, is stored in non-volatile memory 1822. By way of illustration, and not limitation, non-volatile memory 1822 can include read only memory (ROM), programmable ROM (PROM), electrically programmable ROM (EPROM), electrically erasable programmable ROM (EEPROM), or flash memory.

Volatile memory 1820 includes random access memory (RAM), which acts as external cache memory. According to present aspects, the volatile memory may store the write operation retry logic (not shown in FIG. 18) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM),

Computer 1812 may also include removable/non-removable, volatile/non-volatile computer storage media. FIG. 18 illustrates, for example, a disk storage 1824. Disk storage 1824 includes, but is not limited to, devices like a magnetic disk drive, solid state disk (SSD) floppy disk drive, tape drive, Zip drive, LS-110 drive, flash memory card, or memory stick. In addition, disk storage 1824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1824 to the system bus 1818, a removable or non-removable interface is typically used, such as interface 1826.

It is to be appreciated that FIG. 18 describes software, software in execution, hardware, and/or software in combination with hardware that acts as an intermediary between users and the basic computer resources described in the suitable operating environment 1810. Such software includes an operating system 1828. Operating system 1828, which can be stored on disk storage 1824, acts to control and allocate resources of the computer system 1812. Applications 1830 take advantage of the management of resources by operating system 1828 through program modules 1832, and program data 1834, such as the boot/shutdown transaction table and the like, stored either in system memory 1816 or on disk storage 1824. It is to be appreciated that the claimed subject matter can be implemented with various operating systems or combinations of operating systems. For example, applications 1830 and program data 1834 can include software implementing aspects of this disclosure.

A user enters commands or information into the computer 1812 through input device(s) 1836, non-limiting examples of which can include a pointing device such as a mouse, trackball, stylus, touch pad, keyboard, microphone, joystick, game pad, satellite dish, scanner, TV tuner card, digital camera, digital video camera, electronic nose, web camera, and any other device that allows the user to interact with computer 1812. These and other input devices connect to the processing unit 1814 through the system bus 1818 via interface port(s) 1838. Interface port(s) 1838 include, for example, a serial port, a parallel port, a game port, and a universal serial bus (USB). Output device(s) 1840 use some of the same type of ports as input device(s) 1838. Thus, for example, a USB port may be used to provide input to computer 1812, and to output information from computer 1812 to an output device 1840. Output adapter 1842 is provided to illustrate that there are some output devices 1840 like monitors, speakers, and printers, among other output devices 1840, which require special adapters. The output adapters 1840 include, by way of illustration and not limitation, video and sound cards that provide a means of connection between the output device 1840 and the system bus 1818. It should be noted that other devices and/or systems of devices provide both input and output capabilities such as remote computer(s) 1844.

Computer 1812 can operate in a networked environment using logical connections to one or more remote computers, such as remote computer(s) 1844. The remote computer(s) 1844 can be a personal computer, a server, a router, a network PC, a workstation, a microprocessor based appliance, a peer device, a smart phone, a tablet, or other network node, and typically includes many of the elements described relative to computer 1812. For purposes of brevity, only a memory storage device 1846 is illustrated with remote computer(s) 1840. Remote computer(s) 1840 is logically connected to computer 1812 through a network interface 1848 and then connected via communication connection(s) 1850. Network interface 1848 encompasses wire and/or wireless communication networks such as local-area networks (LAN), wide-area networks (WAN), and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1850 refers to the hardware/software employed to connect the network interface 1848 to the bus 1818. While communication connection 1850 is shown for illustrative clarity inside computer 1812, it can also be external to computer 1812. The hardware/software necessary for connection to the network interface 1848 includes, for exemplary purposes only, internal and external technologies such as, modems including regular telephone grade modems, cable modems and DSL modems, ISDN adapters, wired and wireless Ethernet cards, hubs, and routers.

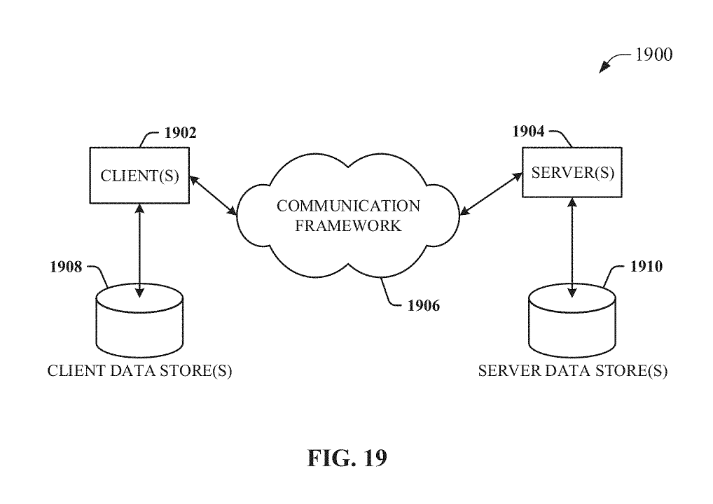

FIG. 19 illustrates a diagram of an example, non-limiting computing environment 1900 in accordance with one or more embodiments described herein. Repetitive description of like elements employed in other embodiments described herein is omitted for sake of brevity. The computing environment 1900 can includes one or more clients 1902, (e.g., computers, smart phones, tablets, cameras, PDA's). The one or more clients 1902 can be hardware and/or software (e.g., threads, processes, computing devices). The one or more clients 1902 can house cookie(s) and/or associated contextual information by employing the specification, for example.

The computing environment 1900 can also includes one or more server(s) 1904. The server(s) 1904 can also be hardware or hardware in combination with software (e.g., threads, processes, computing devices). The servers 1904 can house threads to perform transformations of media items by employing aspects of this disclosure, for example. One possible communication between a client 1902 and a server 1904 can be in the form of a data packet adapted to be transmitted between two or more computer processes wherein data packets may include coded analyzed headspaces and/or input. The data packet can include a cookie and/or associated contextual information, for example. The system 1900 includes a communication framework 1906 (e.g., a global communication network such as the Internet) that can be employed to facilitate communications between the client(s) 1902 and the server(s) 1904.

Communications can be facilitated via a wired (including optical fiber) and/or wireless technology. The client(s) 1902 are operatively connected to one or more client data store(s) 1908 that can be employed to store information local to the client(s) 1902 (e.g., cookie(s) and/or associated contextual information). Similarly, the server(s) 1904 are operatively connected to one or more server data store(s) 1911 that can be employed to store information local to the servers 1904.

In one exemplary implementation, a client 1902 can transfer an encoded file, (e.g., encoded media item), to server 1904. Server 1904 can store the file, decode the file, or transmit the file to another client 1902. It is to be appreciated, that a client 1902 can also transfer uncompressed file to a server 1904 and server 1904 can compress the file and/or transform the file in accordance with this disclosure. Likewise, server 1904 can encode information and transmit the information via communication framework 1906 to one or more clients 1902.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein (e.g., detection components, input components, sample delivery components, and the like) can include electrical circuit(s) that can include components and circuitry elements of suitable value in order to implement the aspects of this innovation(s). Furthermore, it can be appreciated that many of the various components can be implemented on one or more integrated circuit (IC) chips. In one exemplary implementation, a set of components can be implemented in a single IC chip. In other exemplary implementations, one or more of respective components are fabricated or implemented on separate IC chips.

What has been described above includes examples of the implementations of the present invention. It is, of course, not possible to describe every conceivable combination of components or methodologies for purposes of describing the claimed subject matter, but it is to be appreciated that many further combinations and permutations of this innovation are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than or equal to 11” can include any and all sub-ranges between (and including) the minimum value of zero and the maximum value of 11, that is, any and all sub-ranges having a minimum value of equal to or greater than zero and a maximum value of equal to or less than 11, e.g., 1 to 5. In certain cases, the numerical values as stated for the parameter can take on negative values.

In addition, while a particular feature of this innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification are not necessarily all referring to the same implementation. Furthermore, the particular features, structures, or characteristics may be combined in any suitable manner in one or more implementations.

Further, references throughout this specification to an “item,” or “file,” means that a particular structure, feature or object described in connection with the implementations are not necessarily referring to the same object. Furthermore, a “file” or “item” can refer to an object of various formats.

As used in this application, the terms “component,” “module,” “system,” or the like are generally intended to refer to a computer-related entity, either hardware (e.g., a circuit), a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. While separate components are depicted in various implementations, it is to be appreciated that the components may be represented in one or more common component. Further, design of the various implementations can include different component placements, component selections, etc., to achieve an optimal performance. Further, a “device” can come in the form of specially designed hardware; generalized hardware made specialized by the execution of software thereon that enables the hardware to perform specific function (e.g., media item aggregation); software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. An intelligent vehicle, comprising:
a sensor array configured to detect a parameter selected from a group comprising an internal parameter and an external parameter, wherein the internal parameter is associated with a first condition that is within the intelligent vehicle, and wherein the external parameter is associated with a second condition that is outside the intelligent vehicle;
a controller comprising processor, wherein the controller is configured to generate a command based on the parameter; and
a communications interface configured to send the command to a device located outside the intelligent vehicle.

2. The intelligent vehicle of claim 1, wherein the device is a computer device located in a building, and wherein the command regards a function to be executed by the computer device in order to manipulate the building.

3. The intelligent vehicle of claim 2, wherein the function is selected from a second group comprising locking a feature of the building and controlling an environment of the building.

4. The intelligent vehicle of claim 1, wherein the device is a second intelligent vehicle, wherein the parameter is the external parameter and regards a road condition, and wherein the command is a warning of the road condition.

5. The intelligent vehicle of claim 1, wherein the communications interface is further configured to receive information, and wherein the controller is further configured to generate the command based on the information.

6. The intelligent vehicle of claim 5, wherein the information is received from a second intelligent vehicle, wherein the information regards a second parameter detected by the second intelligent vehicle, and wherein the intelligent vehicle further comprises a display that presents the command.

7. The intelligent vehicle of claim 1, wherein the parameter is the internal parameter and regards an entity located within the intelligent vehicle, and wherein the command is an alert regarding the entity.

8. The intelligent vehicle of claim 7, wherein the sensor array detects the entity by an audible feature of the entity.

9. The intelligent vehicle of claim 1, wherein the command is an alert, and wherein the device is an emergency system.

10. The intelligent vehicle of claim 1, further comprising a display that presents the command.

11. The intelligent vehicle of claim 1, wherein the device is an intelligent building comprising a second processor, and wherein the communications interface is configured to send the command in response to the intelligent vehicle entering a defined proximity to the intelligent building.

12. The intelligent vehicle of claim 1, wherein the command can initiate a data transfer between the intelligent vehicle and the device.

13. A computer-implemented method, comprising:
detecting, by a system operatively coupled to a processor of an intelligent vehicle, a parameter selected from a group comprising an internal parameter and an external parameter, wherein the internal parameter is associated with a first condition that is within the intelligent vehicle, and wherein the external parameter is associated with a second condition that is outside the intelligent vehicle;
generating, by the system, a command based on the parameter; and
sharing, by the system, the command with a device located outside the intelligent vehicle.

14. The method of claim 13, further comprising displaying the command via a display unit of the intelligent vehicle.

15. The method of claim 13, further comprising manipulating the device through the command.

16. The method of claim 15, wherein the device is a building, and wherein the manipulating comprises controlling an environment of the building.

17. The method of claim 13, wherein sharing the command initiates a transfer of data between the intelligent vehicle and the device.

18. A system for an intelligent vehicle, the system comprising:
a memory that stores computer executable components;
a processor, operably coupled to the memory, and that executes the computer executable components stored in the memory, wherein the computer executable components comprise:
a sensor component that detects a parameter selected from a group comprising an internal parameter and an external parameter, wherein the internal parameter is associated with a first condition that is within the intelligent vehicle, and wherein the external parameter is associated with a second condition that is outside the intelligent vehicle;
a controller component that generates a command based on the parameter; and
a communication component that shares the command with a device located outside the intelligent vehicle.

19. The system of claim 18, wherein the parameter is the internal parameter and the first condition is an entity located within the intelligent vehicle, and wherein the command is an alert regarding the entity.

20. The system of claim 18, wherein the parameter is the external parameter and the second condition is a hazard on a roadway upon which the intelligent vehicle is travelling, and wherein the device is a second intelligent vehicle.
